(19) United States
(12) Patent Application Publication
(10) Pub. No.: US 2025/0374393 A1
(43) Pub. Date: Dec. 4, 2025

(54) METALLURGICAL ELECTRODE CLAMP

(71) Applicant: Boston Electrometallurgical Corporation, Woburn, MA (US)

(72) Inventor: Scott Emmons, Woburn, MA (US)

(73) Assignee: Boston Electrometallurgical Corporation, Woburn, MA (US)

(21) Appl. No.: 19/220,383

(22) Filed: May 28, 2025

Related U.S. Application Data
(60) Provisional application No. 63/653,076, filed on May 29, 2024.

(51) Int. Cl. H05B 7/105

(52) U.S. Cl. CPC H05B 7/105

(57) ABSTRACT

Metallurgical assemblies may include a metallurgical vessel. The assemblies may include an anode stack positioned within the metallurgical vessel. The assemblies may include a structure positioned outward from a peripheral surface of the anode stack. The assemblies may include a clamp seated atop the structure. The clamp may be engageable with the anode stack. The clamp may include a body having an inner surface defining an open interior. The anode stack may be within the open interior. The clamp may include a clamping surface coupled with the body that is moveable relative to the inner surface to selectively engage the anode stack. The clamp may include a tightening mechanism that is operably coupled to the clamping surface and that adjusts a position of the clamping surface. The clamp may include an electrically insulating member between the body and the support structure to electrically isolate the clamp from the structure.

### CROSS-REFERENCE TO RELATED APPLICATION

This application claims priority to U.S. Provisional Application No. 63/653,076, filed May 29, 2024 titled “METALLURGICAL ELECTRODE CLAMP”, the entirety of which is hereby incorporated by reference herein.

### BACKGROUND OF THE INVENTION

Metallurgical vessels and systems are used for a variety of processes including primary metal extraction, smelting and refining operations that may encompass molten oxide electrolysis, for example. Conventional vessels and systems to conduct such processes may utilize consumable electrodes, which must be fed deeper into the vessel as the electrode is reacted or consumed away during the process. When a specific portion of the electrode has been consumed, the electrode must be replaced or a new section added. Oftentimes, this operation requires disruption to the process as a new electrode is affixed to the system and inserted within the vessel and might require the metallurgical system to be shut down. The process disruption or shut down may not only add time to the processing operations, but also may cause significant heat loss within the vessel. Heat losses usually have a deleterious effect on process control and stability. Thus, there is a need for improved vessels and systems that may enable more efficient movement and replacement of electrodes. These and other needs are addressed by the present technology.

### BRIEF SUMMARY OF THE INVENTION

Metallurgical assemblies may include a metallurgical vessel. The assemblies may include an anode stack positioned partially within the metallurgical vessel. The assemblies may include a support structure positioned laterally outward from a peripheral surface of the anode stack. The assemblies may include a clamp seated atop the support structure. The clamp may be engageable with the anode stack. The clamp may include a clamp body having an inner surface that defines an open interior. The anode stack may be received within the open interior. The clamp may include a clamping surface coupled with the clamp body and that is laterally moveable relative to the inner surface to selectively engage the peripheral surface of the anode stack. The clamp may include a tightening mechanism that is operably coupled to the clamping surface and that is configured to adjust a lateral position of the clamping surface. The clamp may include at least one electrically insulating member disposed between a bottom surface of the clamp body and an upward-facing surface of the support structure to electrically isolate the clamp from the support structure.

In some embodiments, the support structure may form a top of the metallurgical vessel. The clamping surface may be arc-shaped. A radius of the clamping surface may be between 95% and 105% of a radius of the anode. The clamping surface may include a first clamping surface. The tightening mechanism may include a first mechanism. The clamp may include a second clamping surface coupled to the clamp body at a different azimuthal position of the clamp body from the first clamping surface. The clamp may include a second tightening mechanism operably coupled to the second clamping surface configured to adjust a lateral position of the second clamping surface. The first tightening mechanism and the second tightening mechanism may be accessible from a single side of the anode. The at least one electrically insulating member may be coupled with the bottom surface of the clamp body.

Some embodiments of the present technology may encompass metallurgical electrode clamps. The clamps may include a clamp body having an inner surface that defines an open interior. The clamps may include a clamping surface coupled to the clamp body and that is laterally moveable relative to the inner surface. The clamps may include a tightening mechanism that is operably coupled to the clamping surface and that is configured to adjust a lateral position of the clamping surface. The clamps may include at least one electrically insulating base member coupled to a bottom surface of the clamp body.

In some embodiments, the clamping surface may include a first clamping surface. The tightening mechanism may include a first mechanism. The metallurgical electrode clamp may include a second clamping surface coupled to the clamp body at a different azimuthal position of the clamp body from the first clamping surface. The metallurgical electrode clamp may include a second tightening mechanism operably coupled to the second clamping surface configured to adjust a lateral position of the second clamping surface. The first and second tightening mechanisms may be oriented in a same direction relative to the clamp body. A tightening member of each of the first and second tightening mechanisms may be positioned on a same half of the clamp body. The clamp body may include a first semi-annular body and a second semi-annular body. First ends of the first semi-annular body and the second semi-annular body may be removably joined together and second ends of the first semi-annular body and the second semi-annular body may be removably joined together. The first ends of the first semi-annular body and the second semi-annular body may be joined by a first removable pin and second ends of the first semi-annular body and the second semi-annular body may be removably joined by a second removable pin. The clamping surface may include at least one row of serrations. The clamping surface may be disposed on an inward side of a cleat. An outward side of the cleat may include an angled surface. The tightening mechanism may include a wedge body that is movable within a channel. Movement of the wedge body within the channel may apply a lateral force to the angled surface of the cleat to adjust a lateral position of the clamping surface relative to the inner surface of the clamp body. The clamping surface may be one of a plurality of clamping surfaces. The plurality of clamping surfaces may be configured to collectively apply a force of between 8500 N and 270000 N. The clamping surface is one of a plurality of clamping surfaces. Each of the plurality of clamping surfaces may be configured to apply a pressure of no more than 50 MPa. The at least one electrically insulating base member may include a plurality of electrically insulating feet. The clamping surface may be arc-shaped.

Some embodiments of the present technology may encompass metallurgical electrode clamps. The clamps may include a clamp body having an inner surface that defines an open interior. The clamps may include a clamping surface coupled to the clamp body and that is laterally moveable relative to the inner surface. The clamps may include a tightening mechanism that is operably coupled to the clamping surface and that is configured to adjust a lateral position of the clamping surface. The clamps may include at least one electrically insulating base member.

### BRIEF DESCRIPTION OF THE DRAWINGS

A further understanding of the nature and advantages of the disclosed technology may be realized by reference to the remaining portions of the specification and the drawings.

FIG. 1 is a schematic front elevation cross-sectional view of a metallurgical system according to embodiments of the present invention.

FIG. 2 is a schematic top plan view of a metallurgical system according to embodiments of the present invention.

FIG. 3A is a front isometric view of an electrode seal according to embodiments of the present invention.

FIG. 3B is a rear isometric view of the electrode seal of FIG. 3A.

FIG. 3C is a front isometric view of the electrode seal of FIG. 3A in an open configuration.

FIG. 3D is a detailed view of a latching mechanism of the electrode seal of FIG. 3A in a closed configuration.

FIG. 3E is a detailed view of the latching mechanism of the electrode seal of FIG. 3D in a partially open configuration.

FIG. 3F is a top plan view of the electrode seal of FIG. 3A in a closed configuration.

FIG. 3G is a top plan view of the electrode seal of FIG. 3A in a partially open configuration.

FIG. 3H is a cross-sectional view of an upper sealing element of the electrode seal of FIG. 3A.

FIG. 3I is a cross-sectional view of a bottom sealing element of the electrode seal of FIG. 3A.

FIG. 3J is a cross-sectional view of an end sealing element of the electrode seal of FIG. 3A.

FIG. 4 is an isometric view of a downforce mechanism according to embodiments of the present invention.

FIG. 4A is a partial cross-sectional view of an insulating button of the downforce mechanism of FIG. 4.

FIG. 5A is a front elevation cross-sectional view of a metallurgical system according to embodiments of the present invention.

FIG. 5B is a partial isometric cross-sectional view of the metallurgical system of FIG. 5A.

FIG. 6A is an isometric view of a lower clamp according to embodiments of the present invention.

FIG. 6B is a top plan view of the lower clamp of FIG. 6A.

FIG. 6C is a detailed top plan view of a tightening mechanism and cleat of the lower clamp of FIG. 6A.

FIG. 7A is a partial isometric cross-sectional view of a metallurgical system according to embodiments of the present invention.

FIG. 7B is a front elevation cross-sectional view of the metallurgical system of FIG. 7A.

FIG. 8A is a front elevation view of a stem assembly according to embodiments of the present invention.

FIG. 8B is a side elevation cross-sectional view of the stem assembly of FIG. 8A.

FIG. 8C is a front elevation view of the stem assembly of FIG. 8A engaged with a crane.

FIG. 9A is an isometric view of a fixed body of an upper clamp according to embodiments of the present invention.

FIG. 9B is a rear isometric view of a clamp body of an upper clamp of FIG. 9A.

FIG. 9C is a front isometric view of a clamp body of an upper clamp of FIG. 9A.

FIG. 9D illustrates a side elevation view of the upper clamp of FIG. 9A securing a stem of a stem assembly in a loosened configuration.

FIG. 9E illustrates a side elevation view the upper clamp of FIG. 9A securing a stem of a stem assembly in a tightened configuration.

FIG. 9F illustrates a side elevation cross-sectional view of the upper clamp of FIG. 9A coupled to a support structure and busbar.

FIG. 10 is a flowchart illustrating a regrip process according to embodiments of the present invention.

FIG. 11A is a front elevation cross-sectional view of a metallurgical system with a lower clamp engaged according to embodiments of the present invention.

FIG. 11B is a front elevation cross-sectional view of the metallurgical system of FIG. 11A with an upper clamp disengaged.

FIG. 11C is a front elevation cross-sectional view of the metallurgical system of FIG. 11A with a support structure in a raised position.

FIG. 11D is a front elevation cross-sectional view of the metallurgical system of FIG. 11A with the lower clamp disengaged and upper clamp engaged.

FIG. 12 is a flowchart illustrating a process for adding additional anode segments to an anode stack according to embodiments of the present invention.

FIG. 13A is a front elevation cross-sectional view of a metallurgical system with a lower clamp engaged according to embodiments of the present invention.

FIG. 13B is a front elevation cross-sectional view of the metallurgical system of FIG. 13A with an upper clamp disengaged.

FIG. 13C is a front elevation cross-sectional view of the metallurgical system of FIG. 13A with a first stem assembly removed.

FIG. 13D is a front elevation cross-sectional view of the metallurgical system of FIG. 13A with a second stem assembly and an additional anode segment added.

FIG. 13E is a front elevation cross-sectional view of the metallurgical system of FIG. 13A with the lower clamp disengaged and upper clamp engaged.

FIG. 14 is a front elevation cross-sectional view of a metallurgical system with anode stacks of different lengths according to embodiments of the present invention.

FIG. 15 is a flowchart illustrating a process for continuously operating a metallurgical system that includes multiple anode stacks according to embodiments of the present invention.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to metallurgical systems and components thereof that enable stacks of electrodes or other electrodes to be regripped at different positions during operation of the metallurgical systems. As used herein, the term electrode is understood to mean an anode, a cathode, or both anodes and cathodes. The regripping capability may facilitate axial translation of the electrode stacks relative to a metallurgical vessel and may reduce or eliminate the need for a bridge or other device that axially moves the electrode stack to have a range of motion that matches a full axial distance of the electrode stack. For example, the bridge (or other device) may be lowered through the full range of travel of the bridge to lower the electrode stack into the vessel. At this time, a lateral surface of the electrode stack may be gripped or clamped to prevent any axial movement of the electrode stack. The electrode stack may be disengaged from the bridge and the bridge may be raised to a higher position. The electrode stack may be engaged with the bridge, and the grip or clamp may be released. This may enable the bridge to be lowered to further lower the electrode stack into the vessel.

Additionally, the regripping capability may enable a continuous electrode feed process that enables new electrode segments to be added to an electrode stack during metallurgical operations such that at least one electrode segment is inserted within the vessel at all times, without the need to cease the metallurgical operations. For example, a clamping force that inhibits axial or longitudinal motion of the electrode may be applied to a portion of a first electrode segment that extends above a top surface of a metallurgical vessel. A first stem may be disengaged from a support structure positioned above the vessel and the first stem may be disengaged from a top end of the first electrode segment. A second electrode segment may be coupled to the first electrode segment. A second stem may be coupled to a top end of the second electrode segment. The second stem may be engaged with the support structure and the clamp may be disengaged from the first electrode segment, which enables movement of the support structure to axially move the first electrode segment and the second electrode segment relative to the vessel. Oftentimes, a vessel may include multiple electrode stacks at different locations. Electrode segments may be added to one or more of the electrode stacks at different times, which may enable current to flow to some electrode stacks, while other electrode stacks are having additional electrode segments inserted. In such a manner, any number of electrode stacks or other electrodes may be added to the metallurgical system while not interrupting the operation of the system.

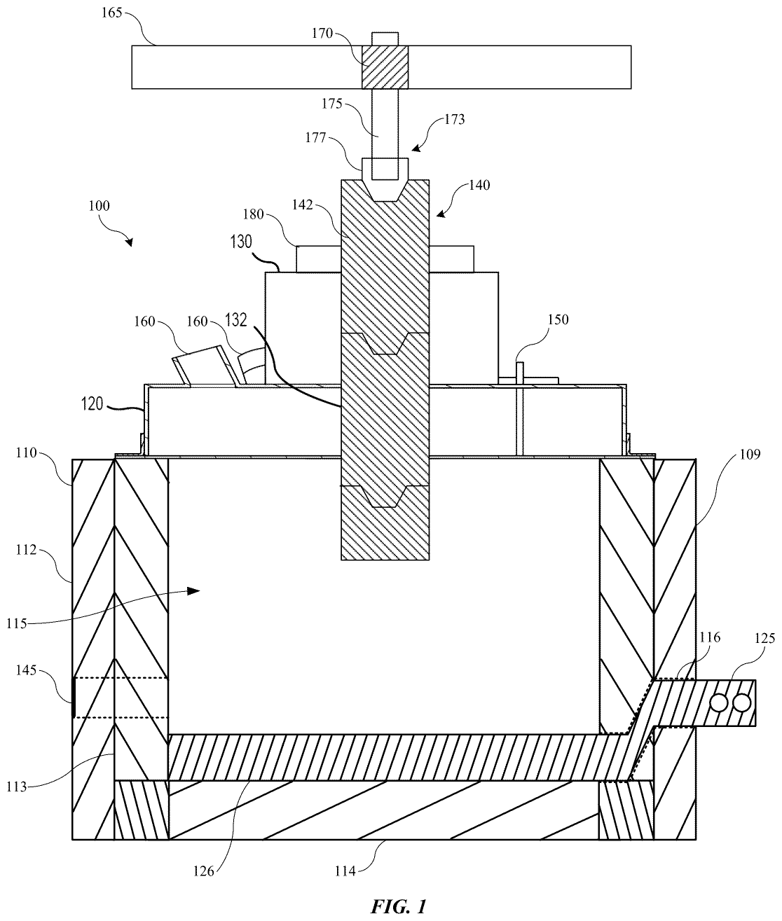

FIG. 1 illustrates a cross-sectional view of an exemplary metallurgical system 100 according to some embodiments of the present technology. The system may be used to generate heat in any number of manners to melt materials housed within. The heat may be produced by high temperature applications to the vessel and may also be developed or generated by electrical energy. The system 100 may include a refractory vessel 110 that may include one or more sides 112 and a base 114. Sides 112 and base 114 may at least partially define an interior volume 115 within refractory vessel 110. Although refractory vessel 110 may include multiple linear and/or arcuate sides 112 to create a rectangular or other vessel shape, in some embodiments a single arcuate surface may be used to generate a circular and/or otherwise round vessel without any corners. Refractory vessel 110 may be used to house one or more materials for processing, such as metal-containing materials, including metal oxides. Refractory vessel 110 may be used in any number of processing configurations, including molten oxide electrolysis, and may include electrolyte materials in addition to a metal-containing material being processed. Refractory vessel 110 may define at least one, and may define a plurality, of apertures 116 in one or more sides 112 of refractory vessel 110. Apertures 116 may provide access for conductive members associated with a current collector 125 as discussed below.

Metallurgical system 100 may also include a lid 120 utilized in conjunction with refractory vessel 110. Lid 120 may be removably coupled with the refractory vessel 110 and may be directly and/or indirectly coupled to refractory vessel 110, such as via one or more fasteners, adhesives, weld joints, and/or other joining techniques. Lid 120 and/or refractory vessel 110 may include a flange that provides a surface of contact for coupling the two components. In some embodiments, lid 120 may include a flange as illustrated, which may define apertures allowing lid 120 to be secured to refractory vessel 110. In operation, lid 120 may be coupled with refractory vessel 110 to form a seal, which may be a liquid seal, or may be a hermetic seal. Additionally, in some embodiments, lid 120 may be coupled with refractory vessel 110 to facilitate containment and/or collection or removal of produced effluent materials including gas byproducts. In some embodiments, lid 120 may be configured to form a partially, substantially, or completely hermetic seal with refractory vessel 110. Lid 120 may define a plurality of apertures through the lid 120 structure, such as to accommodate multiple electrodes, as will be discussed in greater detail below.

Metallurgical system 100 may also include one or more current collectors 125 positioned proximate base 114 of refractory vessel 110. Each current collector 125 may be and/or include a conductive bar or assembly associated with or seated within refractory vessel 110. In some embodiments, each current collector 125 may include conductive extensions 126 positioned within apertures 116 formed within sides 112 of refractory vessel 110.

Metallurgical system 100 may include a gas seal 130 coupled about a first aperture 132 defined through lid 120. The gas seal 130 may be configured to receive and pass a moveable electrode 140 through gas seal 130 and first aperture 132 defined through lid 120. While shown with a single electrode stack 140, it will be appreciated that metallurgical system 100 may include any number of electrode stacks 140. For example, metallurgical system 100 may include at least one electrode stack 140, at least two electrode stacks 140, at least three electrode stacks 140, at least four electrode stacks 140, at least five electrode stacks 140, at least six electrode stacks 140, at least seven electrode stacks 140, at least eight electrode stacks 140, at least ten electrode stacks 140, at least twelve electrode stacks 140, at least fourteen electrode stacks 140, at least sixteen electrode stacks 140, at least eighteen electrode stacks 140, at least twenty electrode stacks 140, or more. Each electrode stack 140 may be formed from one or more electrode segments 142, which may enable electrode stack 140 to be added to and continuously fed into refractory vessel 110 indefinitely, as will be discussed in greater detail below. Each electrode segment 142 may be formed from carbon or some other conductive material in embodiments. Depending on the process being performed within refractory vessel 110, electrode stack 140 may be moved in one or more ways. The process itself may at least partially consume carbon in an oxidation reaction, for example, which may produce carbon monoxide, carbon dioxide, or some other carbon-containing material, although in some embodiments electrode segments 142 may be inert and may be substantially maintained during operation. During a process in which electrode segments 142 are consumed, electrode stacks 140 may be repositioned, such as by being lowered further into interior volume 115, in order to maintain contact with the electrolyte material, maintain a particular distance between electrode stack 142 and the system cathode, or provide additional material for consumption. Additionally, during tapping operations, the level of material within refractory vessel 110 may drop, and electrode stack 140 may be lowered as well to maintain a reaction during tapping. Other scenarios may similarly be encompassed in which electrode stack 140 is translated during operation. Although illustrated as including a single electrode stack 140, various embodiments may include multiple electrode stacks and electrode stack holding systems depending on the size and shape of the vessel and distribution of cathode materials or current collectors.

Gas seal 130 may be included to allow vertical translation of electrode stack 140, while maintaining or substantially maintaining a hermetic seal. For example, first aperture 132 through lid 120 may be sized to accommodate multiple sizes of electrode stacks 140 or may include a tolerance to allow movement of electrode stack 140 during operation. A gap that may exist about electrode stack 140 within first aperture 132 may provide a path of egress for gas formed during operations. The produced gas may include constituents that may be harmful if released untreated, or may represent heat loss from the system, reducing efficiency of the process performed. Accordingly, gas seal 130 may be formed or configured to limit gas release from refractory vessel 110 through first aperture 132 defined through lid 120. Gas seal 130 may include multiple plates bolted or bonded together and may include one or more gaskets to form a vapor barrier about electrode stack 140.

Refractory vessel 110 may include a number of layers and materials in embodiments of the technology. Although FIG. 1 illustrates a two-layer refractory vessel, it is to be understood that refractory vessels according to the present technology may include 1, 2, 3, 4, 5, or more layers in a variety of configurations in embodiments. As illustrated, refractory vessel 110 includes multiple layers, and may include at least two layers of material in embodiments. Refractory vessel 110 may include an exterior layer of material 109, which may be an insulating material configured to reduce heat loss from the refractory vessel. Refractory vessel 110 may also include an interior layer of material 113, which may be contacted by one or more materials within refractory vessel 110 including electrolyte components. The interior layer of material 113 may include a material configured to be chemically compatible with an electrolyte contained within the interior volume 115 of the refractory vessel 110. This material may be a material particular to a chemical process being performed within refractory vessel 110. For example, material 113 may be a material chemically inert to one or more components of an electrolyte, or the material may be composed of materials capable of withstanding temperature, pressure, and/or chemical conditions within interior volume 115 of refractory vessel 110.

Refractory vessel 110 may also include an intermediate layer of material in some embodiments. The intermediate layer of material may provide stability to the refractory vessel in terms of structure, temperature, reactivity, or other characteristics. Each of the layers of material may be included in various forms. For example, each layer of material may form part of sides 112 and/or base 114. As illustrated in FIG. 1, interior layer of material 113 may form interior sidewalls of refractory vessel 110, while exterior layer of material 109 may form the interior base and may define apertures through one or more sides 112 of refractory vessel 110. In some embodiments the interior layer may also include a base portion and may fully define the interior volume of refractory vessel 110. A cooling jacket may be positioned about refractory vessel 110 and may flow one or more cooling fluids about the refractory vessel. The cooling jacket may additionally include a reflective surface to reduce radiative heat loss from refractory vessel 110. In some embodiments, natural convection may cool each side 112 through which current collector 125 extends. For example, local heating of air near the surface of each side 112 through which current collector 125 extends may permit a convective current to form that may cool current collector 125. It is to be understood that other configurations are possible in which materials form one or more regions of refractory vessel 110, and these configurations are similarly encompassed by the present technology.

Refractory vessel 110 may be designed from a number of materials in typical furnace production including fire clays, and various non-metal materials including oxides of various elements. By way of example, refractory vessel 110 may be composed of metals or ceramics, and may include oxides, carbides, and/or nitrides of silicon, calcium, magnesium, aluminum, and boron. Refractory vessel materials may also include one or more of iron, steel, niobium, titanium, chromium, zirconium, as well as oxides, nitrides, and other combinations including one or more of these materials. Additional materials may be used where the material or materials are capable of withstanding temperatures above or about 500° C., above or about 1,000° C., above or about 1,500° C., above or about 2,000° C., above or about 2,500° C., above or about 3,000° C., above or about 3,500° C., above or about 4,000° C., or higher. Unlike many conventional vessels, such as many Hall-Heroult vessels that may be limited to temperatures below or about 1,000° C., the present vessels may be capable of operating at much higher temperatures, facilitating electrochemical processing of many additional metals having melting points above 1,500° C. Additionally, the vessel materials may not react with processing materials contained within the vessel. Refractory vessel 110 may also include one or more ports 145 configured to deliver refined or worked materials from refractory vessel 110. It will be readily appreciated by those of skill that ports 145 may be positioned in any number of locations and should not be considered limited to the exemplary design illustrated.

The refractory vessel materials may also be formed or include materials characterized by particular thermal characteristics. For example, interior layer of material 113 may be characterized by a higher thermal conductivity than exterior layer of material 109, which may be an insulating layer. Any of the refractory vessel materials may be characterized by a thermal conductivity below or about 30 W/(m·K), and may be characterized by a thermal conductivity below or about 25 W/(m·K), below or about 20 W/(m·K), below or about 15 W/(m·K), below or about 10 W/(m·K), below or about 5 W/(m·K), below or about 3 W/(m·K), below or about 2 W/(m·K), below or about 1 W/(m·K), below or about 0.5 W/(m·K), or less. The thermal conductivity of each layer may also be any smaller range within any of these stated ranges, such as between about 0.5 W/(m·K) and about 2 W/(m·K) or a smaller range within this or other noted ranges.

Lid 120 may also define one or more apertures 150, which may include injection apertures and/or sensing apertures. Some operations may benefit from injection of gas during the operation. Apertures 150 may include gas feed apertures may allow incorporation of various elements into the refractory vessel. Gas feed apertures may include a nozzle or port to which gas lines may be coupled and/or may include inlets into which gas piping may be inserted. Apertures 150 may also include apertures for sensing equipment including temperature, pressure, electrical, and other probes or devices for performing sensing operations. The sensors and equipment utilized may be specifically configured to operate at temperatures up to, above, or about 1,000° C., above or about 2,000° C., above or about 3,000° C., or higher. However, many standard sensors may be utilized from the unique operating perspective of the present technology. The described systems may produce a localized heat effect within the vessel, which may provide various locations about the vessel having temperatures that may be several hundred degrees below a central portion of the vessel. This may allow incorporation of sensors and other equipment that could not historically be included in some conventional systems, such as electric arc furnaces, due to the radiative transfer of heat at temperatures that may exceed 2,000° C. Similar to other apertures defined in lid 120, apertures 150 may provide a seal to limit or prevent gas loss or sputtering from refractory vessel 110.

Lid 120 may also include one or more access ports 160, which may extend from lid 120 in various directions, locations, or at various angles. Access ports may include threaded regions or other gasket or flange connections, which may allow access ports 160 to be sealed with a cap or other closure during operation to limit or prevent gas release. The access ports may facilitate visual inspection, testing, or other operations by providing various access to regions of refractory vessel 110. Access ports 160 may be distributed about lid 120 as illustrated to provide access to different regions of refractory vessel 110 during operation. Lid 120 may include any number of each aperture type through lid 120, and the illustrated configuration is merely a single possible configuration encompassed by the present technology. It is to be understood that other configurations, aperture numbers, and aperture combinations are similarly encompassed by the present technology.

In some embodiments, current collector 125 and/or electrode stack 140 may not be electrically connected with refractory vessel 110. The components may also be electrically isolated from lid 120. Refractory vessel 110 may be allowed to electrically float, which may limit or prevent electrical grounding of the electrochemical cell. In this way, during operational events in which stray current shorts from internal contents to refractory vessel 110 and/or lid 120, there is not necessarily a short to ground.

Metallurgical system 100 may include a support structure 165 that is positioned above refractory vessel 110. For example, support structure 165 may include a bridge that extends over all or a portion of refractory vessel 110. In some embodiments, the bridge may include one or more I-beams and/or other structural members. Support structure 165 may include a busbar (not shown) that may be used to carry current to and/or from one or more components coupled to support structure 165, such as electrode stack 140. All or part of support structure 165 may be vertically translatable, which may facilitate operations such as feeding electrode stack 140 into refractory vessel 110 and/or adding additional electrode segments to electrode stack 140. In some embodiments, support structure 165 may include and/or otherwise be coupled to one or more stem clamps 170. Each stem clamp 170 may be mounted on support structure 165 and may be used to secure electrode stack 140 to support structure 165. For example, electrode stack 140 may be removably coupled to a stem 175 of a stem assembly 173, such as by using an electrode coupler 177 that couples stem 175 and electrode stack 140. Stem 175 may be secured within stem clamp 170 to suspend stem assembly 173 and electrode stack 140 from support structure 165. Stem clamp 170 may be disengaged from stem 175 to enable stem 175 and/or support structure 165 to move independently of one another. Metallurgical system 100 may include a electrode clamp 180 that may be selectively engaged and/or disengaged from electrode stack 140. Electrode clamp 180 may be seated atop lid 120, gas seal 130, and/or another support structure or structural element of metallurgical system 100. Electrode clamp 180 may be engaged with a peripheral surface of electrode stack 140 in some embodiments. When engaged with electrode stack 140, electrode clamp 180 may inhibit electrode stack 140 from moving in an axial direction relative to refractory vessel 110. In an engaged position, electrode clamp 180 may fully support the weight of electrode stack 140, which may enable stem clamp 170 to be disengaged from stem 175 without stem assembly 173 and electrode stack 140 moving axially relative to refractory vessel 110. When stem clamp 170 is disengaged from stem 175, support structure 165 may be raised (or otherwise moved) without causing a corresponding movement of electrode stack 140. For example, when electrode clamp 180 is engaged with electrode stack 140, stem clamp 170 may be disengaged from stem 175 to move support structure 165 and stem clamp 170 relative to electrode stack 140 and stem assembly 173. This movement may provide clearance to accommodate insertion of a new electrode segment 142 to electrode 142 and/or to reset a vertical travel distance for support structure 165 after reaching a lower travel limit as will be discussed in greater detail below.

In some embodiments, the components, systems, or configurations may be implemented in multi-electrode/electrode configurations, such that a metallurgical vessel may include more than one electrode stack and/or more than one current collector and/or conductive extension. A metallurgical vessel configured in this way may implement one or more of the aspects described above, thereby providing a scalable and continuous refining process system.

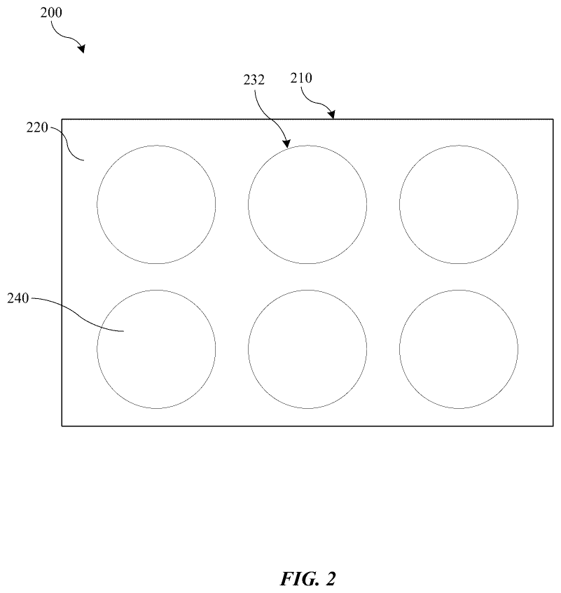

FIG. 2 illustrates a schematic perspective view of an exemplary metallurgical system 200 including multiple electrodes according to some embodiments of the present technology. Metallurgical system 200 may be similar to metallurgical system 100 or any other metallurgical system described herein and may include any of the features described in relation to metallurgical system 100. As illustrated, the metallurgical system 200 may include a refractory vessel 210, which may be similar to refractory vessel 110. A lid 220 may be seated directly and/or indirectly atop refractory vessel 210. Lid 220 may define a number of apertures 232 through a thickness of lid 220. Each aperture 232 may be sized and shaped to receive an electrode stack 240. While illustrated with six apertures 232 and electrode stacks 240 arranged in two rows, it will be appreciated that any number of apertures/electrode stacks may be provided in any arrangement. In embodiments with multiple electrode stacks 240, a spacing between adjacent electrode stacks 240 may be selected to help prevent and/or reduce heat loss within metallurgical system 200. The spacing between adjacent electrode stacks 240 may depend on a size of each electrode stack 240, a number of electrode stacks 240 present within refractory vessel 210, a size and/or shape of refractory vessel 210, and/or other factors. Oftentimes, to help prevent and/or reduce heat loss, electrode stacks 240 may be proximate one another, such as with outer surfaces of adjacent electrode stacks being spaced apart from one another by less than or equal to 2 m, less than or equal to 1.5 m, less than or equal to 1 m, less than or equal to 0.75 m, less than or equal to 0.5 m, less than or equal to 0.4 m, less than or equal to 0.3 m, or less. The close spacing of adjacent electrode stacks 240 may help ensure heat generated as current passes through electrode stacks 240 covers a substantial portion (e.g., greater than 75%, greater than 80%, greater than 85%, greater than 90%, greater than 95%, or more) of a surface area of a base of refractory vessel 210.

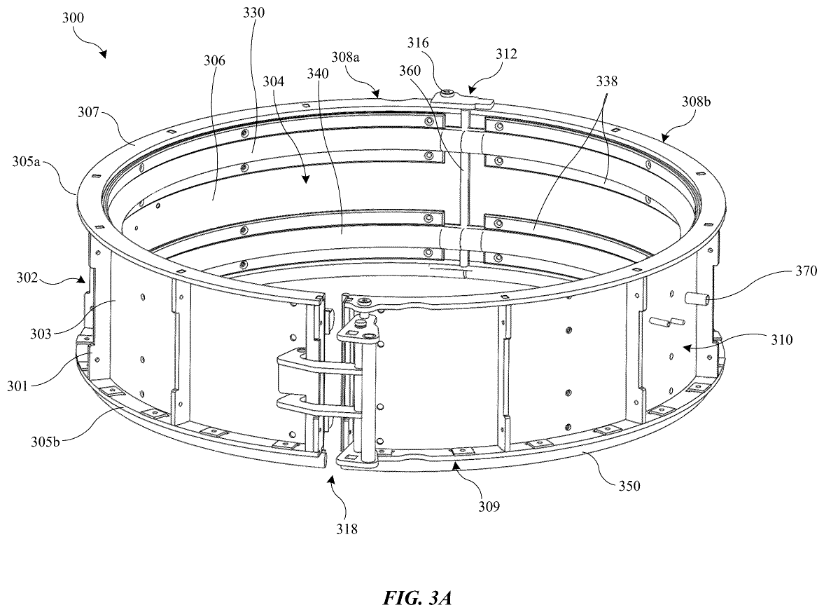

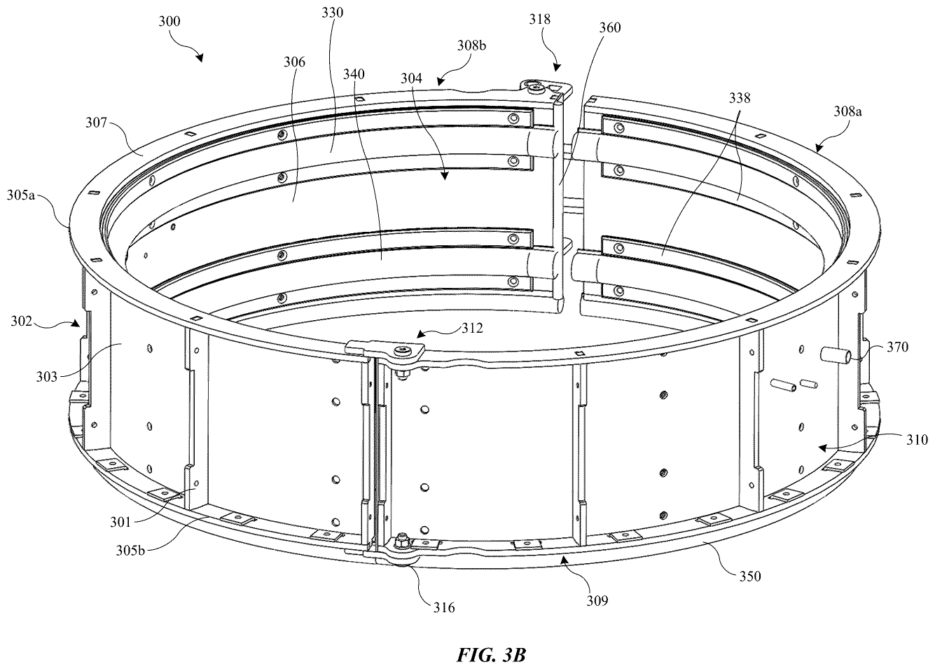

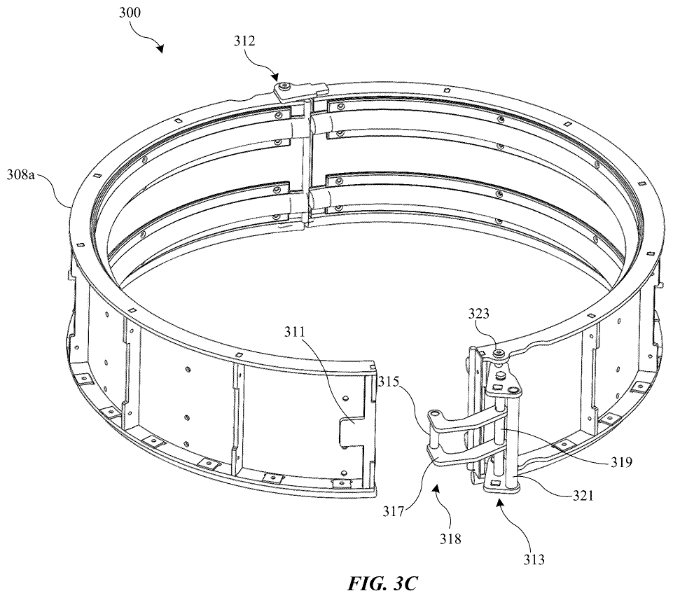

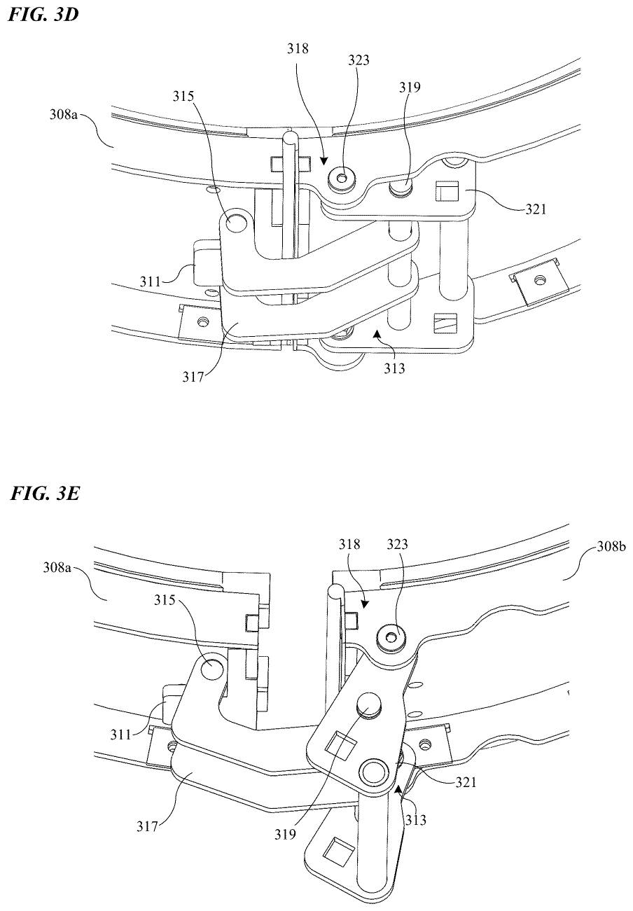

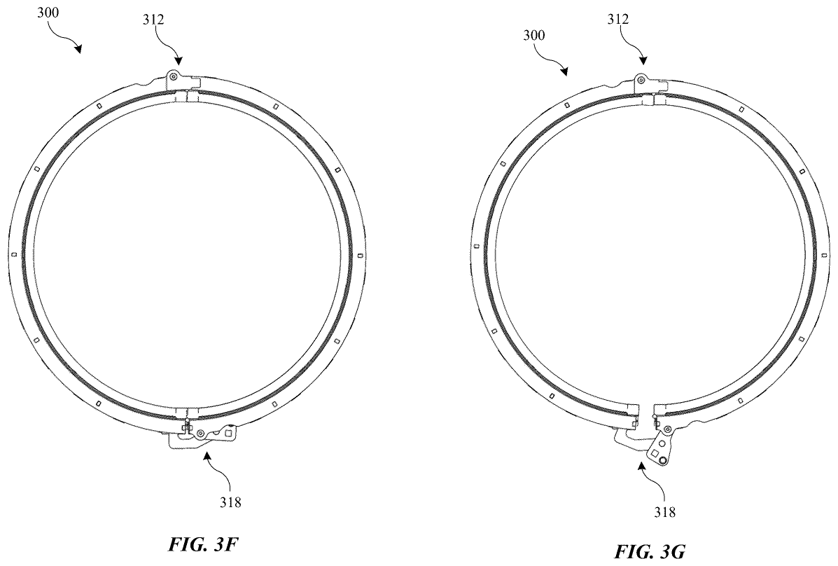

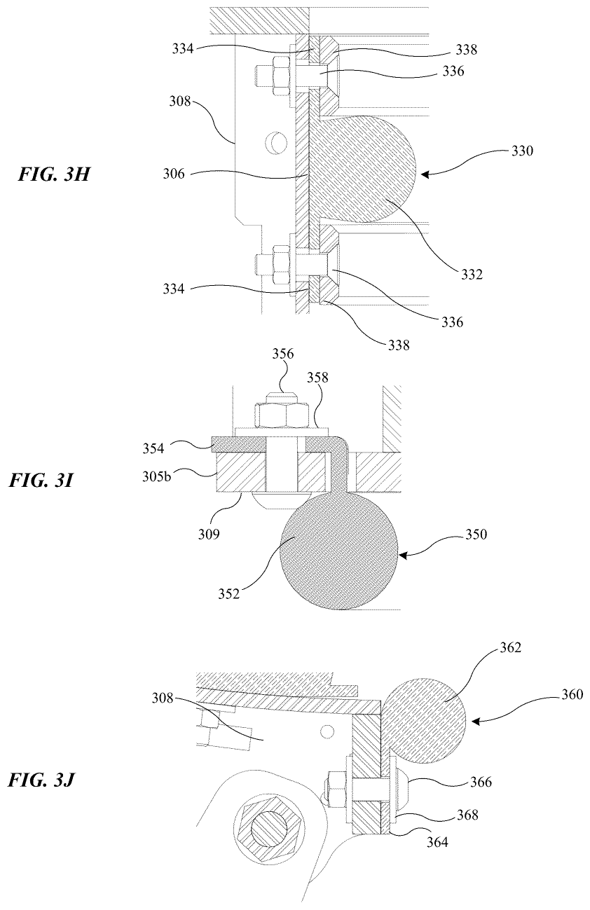

FIG. 3A-3J illustrate one embodiment of an electrode seal 300 that may be used in a metallurgical system. For example, electrode seal 300 may be used in metallurgical system 100, such as for gas seal 130 and/or as another seal disposed between gas seal 130 and electrode clamp 180. Electrode seal 300 may include a body 302 that defines an opening 304. For example, body 302 may include an inner surface 306 having a diameter that defines opening 304. Opening 304 may be circular in shape and may be sized to receive an electrode stack, such as electrode stack 140. For example, opening 304 may have a diameter that is slightly larger than a diameter of the electrode stack to be received in opening 304. In some embodiments, the diameter of opening 304 may be greater than the diameter of the electrode stack by between or about 0.1% and 5%, between or about 0.25% and 2.5%, or between or about 0.5% and 1%, although other values are possible in various embodiments.

In some embodiments, body 302 may be formed as a single component that may be slid and/or otherwise positioned about an electrode stack. In other embodiments, body 302 may be formed from two or more body pieces 308 that may be joined to form body 302. For example, each body piece 308 may define an arc-shaped portion of inner surface 306. As illustrated, body 302 includes two body pieces 308 that may be joined to form body 302, with each body piece 308 defining a semicircular portion of inner surface 306. It will be appreciated that greater numbers of body pieces 308 may be utilized to form body 302 in some embodiments, and that a size and/or shape of each body piece 308 may be the same or different in various embodiments. While illustrated with each body piece 308 being semi-annular, with each body piece 308 having a generally arc-shaped inner surface 306 and outer surface 310, it will be appreciated that other shapes of body pieces 308 are possible, such as those with outer surfaces 310 that are not arc-shaped.

In the illustrated embodiment, body 302 includes a cylindrical collar region 303 that separates two flanges 305 that form upper and lower surfaces of body 302. For example, upper flange 305a may extend radially outward from a top end of collar region 303 and may define an upper surface 307 of body 302. Lower flange 305b may extend radially outward from a bottom end of collar region 303 and may define a lower surface 309 of body 302. Collar region 303 and flanges 305 may have any dimensions to meet the needs of a particular metallurgical system. For example, in embodiments in which multiple electrode stacks are provided within a refractory vessel, with small gaps between adjacent electrode stacks (such as described in relation to FIG. 2), space may be limited to accommodate a thick body 302 due to the presence of one or more electrode stacks on either side and/or a rear of the electrode stack. To address such space limitations, a collective radial thickness of collar region 303 and flanges 305 may be less than or equal to 6 inches, less than or equal to 5 inches, less than or equal to 4 inches, less than or equal to 3 inches, less than or equal to 2 inches, less than or equal to 1 inch, or less. Such dimensions may be particularly useful in embodiments in which the metallurgical system includes a number of electrode stacks spaced in close proximity within a single refractory vessel, as the small radial dimensions of collar region 303 and flanges 305 may ensure that there is sufficient clearance about each electrode stack to receive electrode seal 300.

In some embodiments, a number of ribs 301 may extend radially outward from collar region 303 and couple flanges 305 with one another. Ribs 301 may provide additional structural rigidity to body 302 and may help more uniformly distribute downforce applied to body 302 from upper flange 305a to lower flange 305b, such as to help compress a bottom sealing element 350 against a lid of a refractory vessel as will be discussed in greater detail below. Ribs 301 may be spaced at regular or irregular intervals about body 302. Ribs 301 may also help body 302 maintain its shape at high temperatures and prevent uneven warping that may otherwise occur due to the thermal gradient (e.g., hotter at the bottom than at the top) and high temperatures. In some embodiments in which body 302 is formed from multiple body pieces 308, a rib 301 may be positioned at each end of each body piece 308 to further strengthen body piece 308.

When multiple body pieces 308 are utilized, the body pieces 308 may be permanently and/or reversibly coupled together to form body 302. For example, one or more of the body pieces 308 may be adhered, welded, and/or otherwise coupled with the intention that the coupling will not be reversed. In some embodiments, one or more of the body pieces 308 may be reversibly coupled, such as using pins, magnets, fasteners, latches, and/or other coupling techniques. In some embodiments, ends of two body pieces may be coupled together by a hinge 312 and a latching mechanism 318 that enable body 302 to be opened (as shown in FIG. 3C) or otherwise separated to be positioned about an electrode stack. For example, in some embodiments body 302 may be opened sufficiently far to insert or remove an electrode stack through a gap formed between separated ends of body 302. In other embodiments, body 302 may be opened a shorter distance and may be designed to enable a stem to be inserted or removed through the gap. Hinge 312 and latching mechanism 318 may be locked or otherwise closed about a peripheral surface of the electrode stack. Hinge 312 and latching mechanism 318 may enable electrode seal 300 to be quickly removed from an electrode segment for service or replacement. As illustrated, first ends of each body piece 308 are coupled to one another with a pinned connection that enables first body piece and second body piece to pivot relative to one another to form hinge. To create the pinned connection, each first end of each body piece 308 may include or define one or more apertures or recesses through at least a portion of a height of the respective body piece 308. A pin 316 may be inserted and secured within the aperture or recess, which may enable the two body pieces to pivot and/or rotate relative to one another about the pin 316. In some embodiments, hinge 312 and/or pinned connection may be formed in other ways.

Opposing ends of each body piece 302 may include a portion of latching mechanism 318 or other device that enables body 302 to be locked or removably joined in a closed position that closes open interior 304. For example, in the closed position, open interior 304 may be circular in shape, with each body piece 308 being coupled together end to end. As best illustrated in FIG. 3C, a second end of a first body piece 308a may define a lateral protrusion 311. For example, lateral protrusion 311 may extend from a rib 301 that is at or proximate the second end of body piece 308a. In some embodiments, lateral protrusion 311 may be a substantially planar member that extends substantially orthogonally to rib 301 and/or may be arcuate, such as having a rate of curvature that matches or substantially matches that of collar region 303. A gap may be present between lateral protrusion 311 and collar region 303. A second end of a second body piece 308b may include a latch member 313. Latch member 313 may include a latch catch 315 that is sized to be received within the gap between lateral protrusion 311 and collar region 303. For example, latch catch 315 may include a rod or other elongate member that is insertable within the gap. Latch catch 315 may be coupled to one or more arms 317 that are pivotally coupled to a latch axle 319. Latch axle 319 may be rotatably coupled to a latch handle 321 that enables a user to manipulate latching mechanism 318 between open and closed positions. Latch handle 321 may be pivotally coupled to second body piece 308b, such as via one or more fasteners or pins 323 that each extend through at least one flange 305 and a portion of latch handle 321. To engage latching mechanism 318, latch handle 321 may be rotated about fasteners or pins 323 toward the second end of second body piece 308b to position latch catch 315 beyond a tip of lateral protrusion 311. Latch handle 321 may then be rotated in a reverse direction (e.g., toward a middle of second body piece 308b) to pull latch catch 315 into the gap formed between lateral protrusion 311 and collar region 303 to secure the second ends of body pieces 308 together and to close electrode seal 300 as shown in FIG. 3D. To open electrode seal 300, latch handle 321 may be rotated toward first body piece 308a as shown in FIG. 3E. When latch handle 321 is fully rotated toward first body piece, latch catch 315 is forced out of the gap between lateral protrusion 311 and collar region 303, which may enable second ends of body pieces 308 to be separated.

It will be appreciated that latching mechanism 318 may take other forms that enable electrode seal 300 to be locked in a closed position and to be opened to permit second ends of body pieces 308 to be separated from one another.

In some embodiments, the latching mechanism 318 may be sized to minimally increase a footprint of electrode seal 300. For example, as noted above metallurgical systems having a number of different electrode stacks may have small distances between adjacent electrode stacks to help minimize heat loss within the metallurgical system. The tight spacing between adjacent electrode stacks may limit the space available to interface electrode seal 300 with the electrode stack. Therefore, in some embodiments, in both the closed position (e.g., FIG. 3F) and open position (e.g., FIG. 3G) latching mechanism 318 may extend from an outer surface of body 302 by a distance of no more than 20% of a diameter of the body 302, no more than 15%, no more than 10%, no more than 5%, or less. In some embodiments, the maximum distance the latching mechanism 318 may extend from an outer surface of body 302 may be no more than 6 inches, no more than 5 inches, no more than 4 inches, no more than 3 inches, no more than 2 inches, no more than 1 inch, or less.

Electrode seal 300 may include an upper sealing element 330 that is disposed on an inner surface 306 of body 302. Electrode seal 300 may also include a lower sealing element 340 that is disposed on inner surface 306 of body 302, the lower sealing element 340 being spaced apart from upper sealing element 330 along a longitudinal axis of body 302 and being at a position lower than upper sealing element 330. Upper sealing element 330 and lower sealing element 340 may be positioned against an electrode segment of an electrode stack to seal the interface between electrode seal 300 and the electrode segment. As illustrated, upper sealing element 330 is disposed on an upper half of body 302 and lower sealing element 340 is disposed on a lower half of body, although upper sealing element 330 may be positioned lower on body 302 and/or lower sealing element 340 may be positioned high on body 302 in some embodiments. Upper sealing element 330 may be positioned at a height on body at which upper sealing element 330 is exposed to temperatures that do not exceed 300° C., do not exceed 250° C., do not exceed 200° C., or less. Upper sealing element 330 and lower sealing element 340 may each extend about the entire inner surface, such as extending 360 degrees about open interior 304. In some embodiments, upper sealing element 330 and/or lower sealing element 340 may be single piece components. However, in other embodiments, such as those in which body 302 is formed of multiple body pieces 308 that are joined together, upper sealing element 330 and/or lower sealing element 330 may be formed from multiple segments of material that collectively extend about the entire circumference of inner surface. For example, each body piece 308 may include a separate segment of upper sealing element 330, with the various segments of upper sealing element 330 being in contact with one another when electrode clamp 300 is in the closed position to provide the ability to create a substantially hermetic seal about an electrode positioned within open interior 304. Similarly, each body piece 308 may include a separate segment of lower sealing element 340, with the various segments of lower sealing element 340 being in contact with one another when electrode clamp 300 is in the closed position to provide the ability to create a substantially hermetic seal about an electrode segment positioned within open interior 304. In the illustrated embodiment, each body piece 308 includes substantially semi-circular segments of both upper sealing element 330 and lower sealing element 340. Portions of each segment of upper sealing element 330 that are proximate to the ends of each body piece 308 may be angled in parallel directions to enable the segments to be positioned side by side when electrode clamp 300 is closed, which may provide an enlarged contact area beyond the interface between adjacent segments of upper sealing element 330 (e.g., compared to an end to end connection) that may improve the ability of upper sealing element 330 to create a substantially hermetic seal about an electrode segment positioned within open interior 304. Similarly, portions of each segment of lower sealing element 340 that are proximate to the ends of each body piece 308 may be angled in parallel directions to enable the segments to be positioned side by side when electrode clamp 300 is closed. In some embodiments, portions of some or all segments of upper sealing element 330 and/or lower sealing element 340 may extend beyond the end of the respective body piece 308. The extension of the sealing members beyond the ends of body pieces 308 may enable the different segments of a given sealing member to abut one another beyond the joint between adjacent body pieces 308 to better seal the joint.

Upper sealing element 330 and/or lower sealing element 340 may be coupled with inner surface 306 using adhesives, mechanical couplings, and/or other securement techniques. For example, a portion of each sealing element 330, 340 may be secured to body 302 using one or more clamps, fasteners, or other mechanical features. As illustrated in FIG. 3H, upper sealing element 330 is a tadpole seal that includes a sealing portion 332 and two tails 334 (although no tails (e.g., a round or square rope seal), one tail, or greater than two tails may be present in some embodiments). While not illustrated, it will be appreciated that lower sealing element 340 may have a similar structure. Sealing portion 332 may extend inward from inner surface 306 into open interior 304 and may provide a sealing surface that is positioned against a peripheral surface of an electrode segment when interfaced against an electrode stack. In some embodiments, a diameter (or other lateral dimension measured along a plane bisecting sealing portion 332 along a length of sealing portion 332) of sealing portion 332 may be between or about 0.5 inches and 3 inches, between or about 0.75 inch and 2.5 inches, between or about 1 inch and 3 inches, or any values therebetween. Such thicknesses may allow sealing portion 332 to protrude into open interior 304 by approximately the thickness of sealing portion 332 to provide sufficient room for sealing portion 332 to compress to create a substantially hermetic seal when electrode clamp 300 is closed against an electrode segment. Additionally, by the sealing portion 332 protruding a large distance into open interior 304, sealing portion 332 may accommodate electrode segments that may have non-uniform peripheral surfaces.

As illustrated, each tail 334 may be thinner than sealing portion and may extend upward and/or downward from sealing portion 332. Here, one tail 334 extends above sealing portion 332 and another tail 334 extends below sealing portion 332, although other configurations are possible. Tails 334 may be used to secure upper sealing element 330 to inner surface 306. For example, tails 334 may provide additional contact area between upper sealing element 330 and inner surface 306 to improve adhesion between the components when an adhesive is used to secure upper sealing element 330 to inner surface 306 and/or may provide areas for clamping and/or fastening upper sealing element 330 to inner surface. For example, as illustrated, one or more fasteners 336 (e.g., screws, bolts, rivets, etc.) may be inserted through each tail 334 and may extend into body 302 (such as collar region 303) to secure upper sealing element 330 to inner surface 306. In some embodiments, a head of each fastener 336 may contact the respective tail 334. In other embodiments, one or more intervening components may be interfaced between tail 334 and the head of fastener 336. The intervening components may help distribute the fastening force across a greater surface area of tail 334 and may help increase the lifespan of tail 334. For example, one or more washers may be interfaced between tail 334 and the head of fastener 336. In other embodiments, annular and/or arcuate strips 338 may be positioned against an inner surface of each tail 334 to sandwich each tail 334 between strip 338 and inner surface 306. Fasteners 336 may be inserted through strip 338, tail 334, and body 302 to secure upper sealing element 330 to inner surface 306.

A size and/or material of each sealing element 330, 340 (and in particular each sealing portion 332) may be selected to create a substantially hermetic seal against an electrode segment received within open interior 304, while also permitting the electrode segment to slide axially within electrode seal 300. The ability to slide within electrode seal 300 while maintaining a substantially hermetic seal against the electrode segment may be necessary to enable a refractory vessel to be sealed while continuously feeding electrode segments into the refractory vessel as described elsewhere herein. To enable a seal to be maintained while the electrode stack is slide relative to the electrode seal 300, upper sealing element 330 and/or lower sealing element 340 may be formed from a compressible material that is able to withstand high temperatures (e.g., upwards of 300° C., with lower sealing element 340 being exposed to higher temperatures than upper sealing element 330) while remaining compliant and wear resistant. Upper sealing element 330 and/or lower sealing element 340 may be formed from one or more layers of materials to achieve such benefits. For example, upper sealing element 330 and/or lower sealing element 340 may include a core material that is partially or fully encapsulated by a cover. In a particular embodiment, upper sealing element 330 and/or lower sealing element 340 may include a ceramic core that is surrounded by a mineral-based cover. For example, ceramic core may be a ceramic rope, such as an alumino-silicate based ceramic material or other ceramic material that may withstand high temperatures, while the mineral-based cover may be formed from basalt, silica, and/or other high temperature resistant material, including mineral-based materials. To improve the wear-resistance of upper sealing element 330 and/or lower sealing element 340, all or a portion of a peripheral surface of sealing portion 332 may be coated and/or otherwise covered with a wear-resistant material. In some embodiments, the wear-resistant material may be disposed about an entirety of the outer surface of sealing portion 332, while in other embodiments only a portion (such as a portion of sealing portion 332 that may contact the electrode segment) may include the wear-resistant material. In some embodiments, the wear-resistant material may be selected such that the wear-resistant has a hardness (e.g., Mohs hardness) that is greater than or equal to that of the electrode segment, which may help ensure that as the electrode segment is slide relative to electrode seal 300 that any abrasive damage from the sliding contact is imparted on the electrode segment, rather than sealing portion 332. In a particular embodiment, the wear-resistant material may include a nickel-chromium alloy, such as an Inconel alloy. The wear-resistant material may be applied as a continuous layer of material and/or may be applied intermittently and/or with gaps, such as in the form of a mesh or other patterned application.

While described as having similar structures and/or being formed from similar materials, it will be appreciated that one or more features of upper sealing element 330 and lower sealing element 340 may be different in various embodiments. For example, different coupling techniques may be used to secure each sealing element to inner surface 306.

Electrode seal 300 may include a bottom sealing element 350 that is disposed on bottom surface 309 of body 302, which may be a bottom surface of lower flange 305b in some embodiments. Bottom sealing element 350 may extend about the entire inner bottom surface 309, such as extending 360 degrees about open interior 304. Bottom sealing element 350 may be positioned against a lid of the refractory vessel to seal the interface between electrode seal 300 and the lid. In some embodiments, bottom sealing element 350 may be a single piece component that extends entirely about open interior 304. However, in other embodiments, such as those in which body 302 is formed of multiple body pieces 308 that are joined together, bottom sealing element 350 may be formed from multiple segments of material that collectively extend about the entire circumference of bottom surface 309. For example, each body piece 308 may include a separate segment of bottom sealing element 350, with the various segments of bottom sealing element 350 being in contact with one another when electrode seal 300 is in the closed position to provide the ability to create a substantially hermetic seal against the lid of the refractory vessel. In the illustrated embodiment, each body piece 308 includes a substantially semi-circular segment of bottom sealing element 350. Portions of each segment of bottom sealing element 350 that are proximate to the ends of each body piece 308 may be angled in parallel directions to enable the segments to be positioned side by side when electrode clamp 300 is closed, which may provide an enlarged contact area at the interface between adjacent segments of bottom sealing element 350 (e.g., compared to an end to end connection) that may improve the ability of bottom sealing element 350 to create a substantially hermetic seal against the lid of the refractory vessel.

Bottom sealing element 350 may be coupled with bottom surface 309 using adhesives, mechanical couplings, and/or other securement techniques. For example, a portion of bottom sealing element 350 may be secured to body 302 using one or more clamps, fasteners, or other mechanical features. As illustrated in FIG. 3I, bottom sealing element 350 is a tadpole seal that includes a sealing portion 352 and a tail 354 (although more than one tail may be present in some embodiments). Sealing portion 352 may extend downward from bottom surface 309 and may provide a sealing surface that is positioned against an upper surface of a lid of a refractory vessel. In some embodiments, a diameter (or other lateral dimension measured along a central axis of bottom sealing element 350) of sealing portion 352 may be between or about 0.25 inches and 2 inches, between or about 0.5 inches and 1.75 inches, between or about 0.75 inches and 1.5 inches, between or about 1 inch and 1.25 inches, or any values therebetween. Such thicknesses may allow sealing portion 352 to protrude downward from bottom surface 309 and be compressed between bottom surface 309 and the upper surface of a lid of a refractory vessel to create a substantially hermetic seal when electrode seal 300 is positioned against a lid of a refractory vessel.

As illustrated, tail 354 may be thinner than sealing portion 352 and may extend upward and/or downward from sealing portion 332. Here, tail 354 extends upward from sealing portion 352 and may be used to secure bottom sealing element 350 to bottom surface 309. For example, tail 354 may provide additional contact area between bottom sealing element 350 and bottom surface 309 to improve adhesion between the components when an adhesive is used to secure bottom sealing element 350 to bottom surface and/or may provide areas for clamping and/or fastening bottom sealing element 350 to bottom surface 309. A portion of tail 354 extending beyond the slots may be folded over and positioned against a top surface of bottom flange 305b. One or more fasteners 356 (e.g., screws, bolts, rivets, etc.) may be inserted through each tail 334 and may extend into bottom flange 305b to secure bottom sealing element 350 against bottom surface 309. In some embodiments, a head of each fastener 356 may contact the respective tail 354. In other embodiments, one or more intervening components may be interfaced between tail 354 and the head of fastener 356. The intervening components may help distribute the fastening force across a greater surface area of tail 354 and may help increase the lifespan of tail 354. For example, as illustrated one or more washers 358 may be interfaced between tail 354 and the head of fastener 356. In other embodiments, bottom sealing element 350 may be secured to bottom surface 309 in a similar manner used to secure upper sealing element 330 to inner surface 306. For example, annular and/or arcuate strips may be positioned against a top surface of surface of tail 354 to sandwich tail 354 between the strip and the top surface of bottom flange 305b. Fasteners 356 may be inserted through the strip, tail 354, and bottom flange 305b to secure bottom sealing element 350 against bottom surface 309.

Bottom sealing element 350 may be formed from a compressible material that is able to withstand high temperatures (e.g., upwards of 300° C.) while remaining compliant. Bottom sealing element 350 may be formed from one or more layers of materials in some embodiments. For example, bottom sealing element 350 may include a core material that is partially or fully encapsulated by a cover. In a particular embodiment, bottom sealing element 350 may include a ceramic core that is surrounded by a mineral-based cover. For example, ceramic core may be a ceramic rope, while the mineral-based cover may be formed from basalt and/or other high temperature resistant material.

In some embodiments, rather than being affixed to electrode seal 300, bottom sealing element 350 may be a separated component that may be placed against bottom surface 309. For example, bottom sealing element 350 may be coupled (e.g., via adhesives, fasteners, and/or other mechanical fastening techniques) to the lid of the refractory vessel and/or may be a separate component that may be placed atop the lid and positioned beneath electrode seal 300, without bottom sealing element 350 being fixedly coupled to either the lid or electrode seal 300.

In embodiments in which body 302 is formed from a number of body pieces 308, end sealing elements 360 may be positioned between ends of each adjacent body piece 308. End sealing elements 360 may extend along all, or a substantial portion of a height of each interface between adjacent body pieces 308. End sealing elements 350 may be compressed between ends of adjacent body pieces 308 when seal 300 is in a closed position to seal the interface between the ends of the adjacent body pieces 308. Additionally, end sealing elements 350 may be compressed into a surface (such as a backside) of upper sealing element 330 and/or lower sealing element 340 to ensure that an entire circumference of seal 300 is sealed. In some embodiments, each body piece 308 may include an end sealing element 360 on each end. In other embodiments, each body piece 308 may include an end sealing element 360 on a single end. For example, a first body piece 308 may include an end sealing element 360 on a first end, while a second body piece 308 may include an end sealing element 360 on a second end. When first ends of each body piece 308 are joined together and second ends of each body piece 308 are joined together both interfaces between the two body pieces 308 will include a single end sealing element 360 compressed therebetween. In some embodiments, some of body pieces 308 may include no end sealing elements 360. For example, a first body piece 308 may include an end sealing element 360 on each end, while a second body piece 308 may not include any end sealing elements 360 on either end. When ends of each body piece 308 are joined together, both interfaces between the two body pieces 308 will include a single end sealing element 360 compressed therebetween.

End sealing elements 360 may be coupled with ends of body pieces 308 using adhesives, mechanical couplings, and/or other securement techniques. For example, a portion of each end sealing element 360 may be secured to body 302 using one or more clamps, fasteners, or other mechanical features. As illustrated in FIG. 3J, each end sealing element 360 is a tadpole seal that includes a sealing portion 362 and a tail 364 (although more than one tail may be present in some embodiments). Sealing portion 362 may extend outward from an end surface of body piece 308 and may provide a sealing surface that is compressed between and seals the interface formed between connected ends of adjacent body pieces 308. In some embodiments, a diameter (or other lateral dimension measured along a central axis of end sealing element 360) of sealing portion 362 may be between or about 0.125 inches and 1 inches, between or about 0.25 inches and 0.875 inches, between or about 0.375 inches and 0.75 inches, between or about 0.5 inches and 0.625 inches, or any values therebetween. Such thicknesses may allow sealing portion 362 to compress between connected ends and create a substantially hermetic seal when electrode seal 300 is in the closed position.

As illustrated, tail 364 may be thinner than sealing portion 362 and may extend upward and/or downward from sealing portion 362. Here, tail 364 extends laterally inward and/or outward from sealing portion 362 and may be used to secure end sealing element 360 to end surface. For example, tail 364 may provide additional contact area between end sealing element 360 and end surface to improve adhesion between the components when an adhesive is used to secure end sealing element 360 to end surface and/or may provide areas for clamping and/or fastening end sealing element 360 to end surface. For example, as illustrated, tail 364 is positioned against an end surface. For example, as illustrated, one or more fasteners 366 (e.g., screws, bolts, rivets, etc.) may be inserted through tail 364 and may extend into body 302 to secure end sealing element 360 to the end surface. In some embodiments, a head of each fastener 366 may contact tail 364. In other embodiments, one or more intervening components may be interfaced between tail 364 and the head of fastener 366. The intervening components may help distribute the fastening force across a greater surface area of tail 364 and may help increase the lifespan of tail 364. For example, as illustrated one or more washers 368 may be interfaced between tail 364 and the head of fastener 366. In other embodiments, end sealing element 360 may be secured to end surface in a similar manner used to secure upper sealing element 330 to inner surface 306. For example, a strip may be positioned against an exposed lateral surface of tail 364 to sandwich tail 364 between the strip and the end surface of body 302. Fasteners 366 may be inserted through the strip, tail 354, and into body 302 to secure end sealing element 360 against the end surface.

End sealing element 360 may be formed from a compressible material that is able to withstand high temperatures (e.g., upwards of 300° C.) while remaining compliant. End sealing element 360 may be formed from one or more layers of materials in some embodiments. For example, end sealing element 360 may include a core material that is partially or fully encapsulated by a cover. In a particular embodiment, bottom sealing element 360 may include a ceramic core that is surrounded by a mineral-based cover. For example, ceramic core may be a ceramic rope, while the mineral-based cover may be formed from basalt and/or other high temperature resistant material.

While each sealing element is described as being a tadpole seal, it will be appreciated that other sealing elements, such as O-rings, gaskets, and the like may be utilized in various embodiments. Additionally, any combination of mechanical and/or adhesive couplings may be utilized to secure the sealing elements with body 302. Each sealing element may be secured to body using a same or different technique in various embodiments. In some embodiments, some or all of the sealing elements may be reversibly coupled to body 302 such as, but not limited to, using adhesives and/or fasteners. By reversibly coupling the sealing elements to body 302, worn or damaged sealing elements may be replaced to increase the lifespan of electrode seal 300. For example, electrode seal 300 may be opened and removed from an electrode stack to access the sealing elements for service or replacement.

In some embodiments, a perfect hermetic seal may not be maintained between electrode seal 300 and an electrode segment. For example, pores and/or irregularities in the surface of the electrode segment may cause tiny leaks. Additionally, as the electrode segment is slid within electrode seal 300, upper sealing member 330 and/or lower sealing member 340 may be temporarily deformed in a manner that causes a small leak in the interface formed between the electrode segment and electrode seal 300. These small leaks may cause problems, as oxygen (that may cause air burn of the electrode segments) may be drawn into the refractory vessel through these leaks. For example, the refractory vessel may be operated at a negative pressure to prevent any gases and/or other byproducts of the metallurgical operations from escaping from the refractory vessel at any positions other than exhaust lines. Additionally, the leaks at the electrode segment/electrode seal 300 interface may lead to heat losses. To combat such effects, some embodiments may deliver an inert gas, such as (but not limited to) argon, being delivered to a volume between electrode segment and electrode seal 300. If any leaks occur, the inert gas, rather than air, may be drawn into the refractory vessel. The flow of inert gas may prevent any heat loss and reduce or eliminate the risk of air burn of the electrode segments in the event of a leak.

In some embodiments, body 302 may define one or more gas injection ports 370 that extend through an entire thickness of body 302 to provide a fluid path through which an inert gas (or mixture of gases) may be flowed into the volume between electrode segment and electrode seal 300. Gas injection port 370 may be positioned between upper sealing element 330 and lower sealing element 340 in some embodiments. An inert gas source (not shown) may be coupled with gas injection port 370, such as via one or more gas lumens, to deliver the inert gas into the volume.

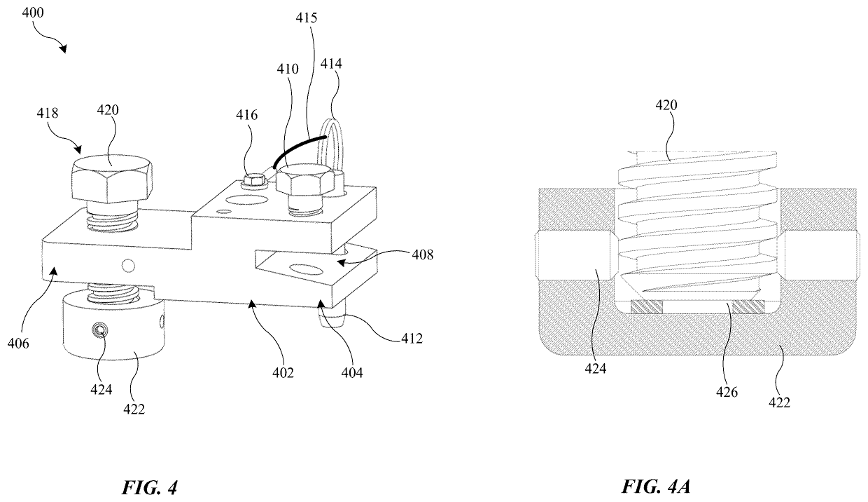

The weight of electrode seal 300 may not be sufficient to ensure that bottom sealing element 350 is sufficiently compressed to create the substantially hermetic seal between the lid of the refractory vessel and electrode seal 300. Therefore, in some embodiments, one or more downforce mechanisms may be provided that are used to apply downforce to electrode seal 300 to help compress bottom sealing element 350 against the top surface of the lid. FIG. 4 illustrates one embodiment of a downforce mechanism 400 that may be used to apply downforce to an electrode seal, such as electrode seal 300. Downforce mechanism 400 may include a body 402 that may include a first end 404 and a second end 406. First end 404 may be configured to couple to a support structure, such as (but not limited to) an I-beam, that may fix downforce mechanism 400 in a set position relative to an electrode seal (such as electrode seal 300) and/or a lid of a refractory vessel. First end 404 may be coupled to the support structure in a number of ways, such as via one or more clamps, fasteners, and/or other mechanical couplings.

As illustrated, first end 404 defines a slit 408 that extends through an end surface of first end 404. Slit 408 may be sized and shaped to receive a portion of the support structure. For example, where the support structure is an I-beam, slit 408 may be sized and shaped to receive a distal end portion of a flange of the I-beam. In some embodiments, one or more fasteners and/or other mechanisms may be used to fix downforce mechanism 400 relative to the I-beam or other support structure. For example, as illustrated, first end 404 includes one or more screws, bolts, or other fasteners 410 that extend from a top surface of first end 404, through a threaded aperture, and through at least a portion of slit 408. In some embodiments, fastener 410 may only be long enough to extend partially through slit 408 when fully tightened, which may enable fastener 410 to be tightened to operate as a set screw to apply force to a top surface of the I-beam or other support structure to prevent downforce mechanism 400 from sliding or otherwise moving relative to the I-beam. In other embodiments, fastener 410 may be long enough to extend fully through slit 408 when fully tightened. The flange of the I-beam may define an aperture through which the fastener 410 may pass, which may enable fastener 410 to be tightened to be inserted through the aperture of the I-beam or other support structure to prevent downforce mechanism 400 from sliding or otherwise moving relative to the I-beam. In some embodiments, instead of or in addition to fastener 410 one or more additional securing mechanisms may be utilized. For example, as illustrated, a removable pin 412 may extend through one or more apertures formed in a top and/or bottom portion of first end 404 defining slit 408. Pin 412 may be inserted through the apertures in first end 404 and through a corresponding aperture formed in the flange of the I-beam to inhibit lateral movement of downforce mechanism 400 relative to the I-beam. In some embodiments, pin 412 may include a ring 414, head, or other component that extends laterally beyond a portion of pin 412 that extends through the apertures. Ring 414 may limit the insertion distance of pin 412 through the apertures and ensure that pin 412 does not fall through the apertures. In some embodiments, downforce mechanism 400 may include a mechanism that helps secure pin 412 to downforce mechanism 400 to prevent pin 412 from being dropped or misplaced when removed from the apertures. For example, a lanyard 415 or other cord may be used to couple pin 412 and downforce mechanism 400, with a length of lanyard 415 being selected to permit pin 412 to be inserted and removed from the apertures. Lanyard 415 may be coupled to downforce mechanism 400 via a fastener 416, clamp, and/or other technique. For example, fastener 416 may be a bolt or screw that extends through an aperture formed through all or part of a thickness of downforce mechanism 400. A head of fastener 416 may compress and secure a portion of lanyard 415 between fastener 416 and downforce mechanism 400 to secure lanyard 415 to downforce mechanism 400.

Second end 406 may include one or more downforce actuators 418 that may be positioned against an upward facing surface (e.g., upper surface 307) of an electrode seal to apply downward force to the electrode seal to help compress the bottom sealing element to improve the seal between the electrode seal and the lid of the refectory vessel. In some embodiments, downforce actuators 418 may be linear actuators that may apply a downward force in a direction that is at least substantially aligned with a central axis of the electrode seal. As illustrated, downforce actuator 418 includes a bolt 420 that is engaged with a threaded aperture that extends through top and bottom surfaces of second end 406. Bolt 420 may be rotated within the threaded aperture to adjust an amount of downforce applied by downforce mechanism 400. For example, bolt 420 may be positioned above and may contact an upward-facing surface of the electrode seal (such as a top surface of upper flange) such that as bolt 420 is rotated to extend further from the bottom surface of second end, a greater amount of downforce is applied to the upper surface of upper flange due to body 402 being fixed in place by engagement with a support structure.

In some embodiments, it may be desirable to electrically isolate the support structure from the refractory vessel, lid, and electrode seal. In such embodiments, one or more electrical isolators may be interfaced between downforce mechanism 400 and electrode seal and/or between downforce mechanism 400 and the support structure. For example, in some embodiments an electrically insulating material (e.g., a coating, layer of insulating material such as a ceramic or polymer, etc.) may be disposed on the upward-facing surface of the electrode seal. Similarly, an electrically insulating material may be disposed on a surface of the support structure that contacts downforce mechanism 400. In the illustrated embodiment, downforce mechanism 400 includes an insulating button 422 that is coupled with a bottom end of bolt 420. Insulating button 422 may electrically isolate bolt 420 and the rest of downforce mechanism 400 from the electrode seal. Insulating button 422 may be formed from any electrically insulating material, such as ceramic and/or polymeric materials. In a particular embodiment, the insulating button may be formed from machinable ceramic or other ceramic and/or a polyether ether ketone (PEEK) material or other polymer.

As illustrated in the cross-section view shown in FIG. 4A, insulating button 422 may define a receptacle or aperture that may receive the bottom end of bolt 420. In some embodiments, the receptacle may be threaded to mate with threads of bolt 420. In other embodiments, bolt 420 may be secured within the receptacle using one more set screws 424 and/or other fasteners that may extend through a sidewall of the insulating button 422 and contact a lateral (e.g., threaded) surface of bolt 420. In some embodiments, set screws 424 may be formed from an electrically insulating material, which may be the same or different than the material used to form insulating button 422. In some embodiments, an insulating washer 426 may be disposed within a bottom of the receptacle. The washer 426 may help prevent insulating button 422 from cracking or otherwise becoming damaged by helping to dissipate any high localized forces from any sharp edges and/or protrusions that may be present on bolt 420.

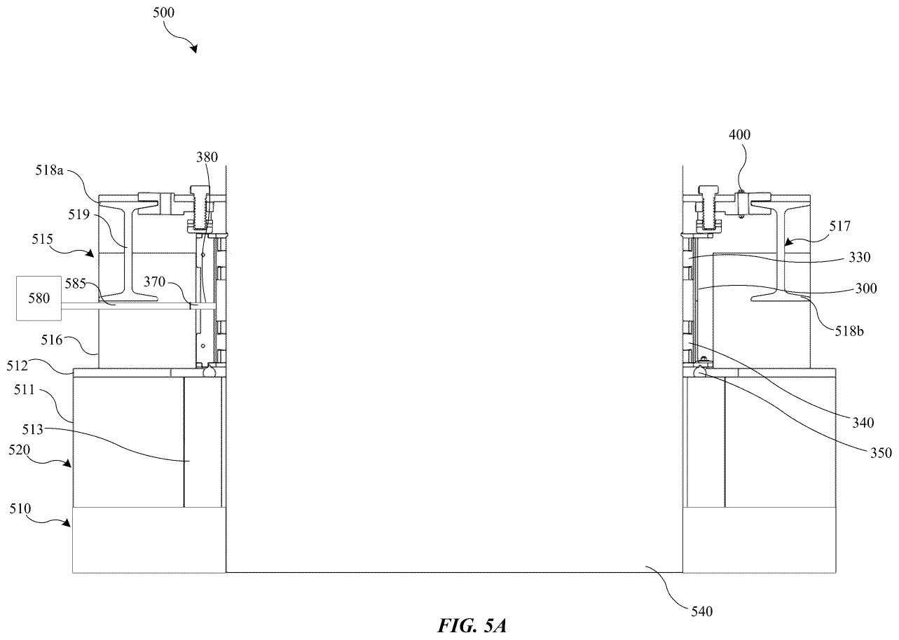

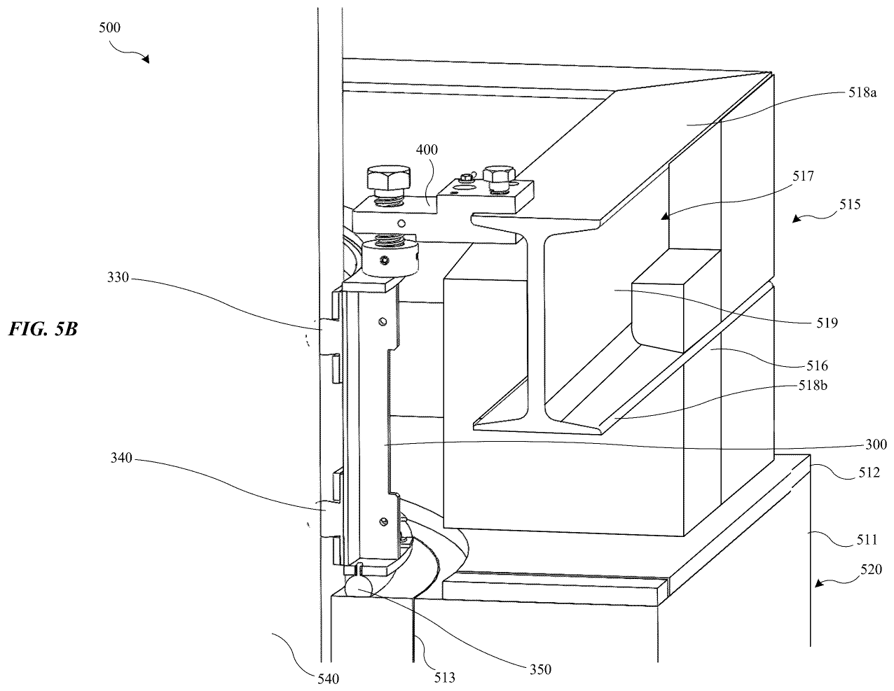

FIGS. 5A and 5B illustrate a portion of a metallurgical system 500. Metallurgical system 500 may be similar to metallurgical systems 100 and 200 and may include any of the features described in relation to metallurgical systems 100 and 200. As illustrated, the metallurgical system 500 may include a refractory vessel 510, which may be similar to refractory vessels 110 and 210. A lid 520 may be seated directly and/or indirectly atop refractory vessel 510 and may define one or more apertures that may each receive an electrode stack 540 (which may be similar to electrode stack 140). Lid 520 may form a top end of vessel 510 and may serve to at least partially close off the interior volume of refractory vessel 510. As illustrated, lid 520 includes one or more refractory layers 511, with one or more plates 512 (such as steel plates) disposed atop refractory layers 511, although other configurations are possible. In some embodiments, lid 520 may include a precast ring 513, which may be disposed along an inner diameter of one or more of the refractory layers 511 and which may form an inner diameter of lid 520. A support structure 515 may be seated atop or otherwise positioned above lid 520 and may be positioned laterally outward from a peripheral surface of the electrode stack 540. Support structure 515 may include one or more blocks 516 that may support a number of I-beams 517 or other structural members that may extend about all or a portion of an opening formed within lid 520. In other embodiments, the I-beams 517 may be supported by other structures, which may be positioned atop lid 520 and/or may otherwise extend above lid 520. As just one example, a separate support structure may be formed from a series of other I-beams and/or other structural members. For example, vertically oriented (e.g., orthogonal to I-beams 517) I-beam columns may be positioned about the vessel, lid 520, and/or the opening formed in lid 520. I-beams 517 may be supported by these vertically oriented I-beam columns. It will be appreciated that the support arrangements described herein are merely meant as examples and that numerous techniques may be utilized to secure I-beams 517 (or other structural members) above and/or atop lid 520. Each I-beam 517 may include two flanges 518 that are separated by a web 519. An upper flange 518a may extend above and be vertically spaced apart from a top surface of blocks 516, while a lower flange 518b may be embedded within blocks 516 in some embodiments.

In some embodiments, electrode seal 300 may be seated atop lid 520, such as with bottom surface 309 being supported atop precast ring 513. Bottom sealing element 350 (whether part of electrode seal 300, precast ring 513, or a separate component) may be positioned and compressed between bottom surface 309 and an upper surface of precast ring 513 (or other surface of lid 520 or other support structure) to seal the interface between electrode seal 300 and lid 520. Upper sealing element 330 and lower sealing element 340 may be engaged with a peripheral surface of an electrode segment of electrode stack 540 to seal the interface between electrode stack 540 and electrode seal 300. Due to the design of upper sealing element 330 and lower sealing element 340, electrode stack 540 is longitudinally slidable within electrode seal 300 when upper sealing element 330 and lower sealing element 340 are engaged with the peripheral surface of an electrode segment of electrode stack 540, which may enable electrode stack 540 to be continuously fed into refractory vessel 510 during operation of metallurgical system 500.

To help compress bottom sealing element 350 between bottom surface 309 and the upper surface of precast ring 513, one or more downforce mechanisms 400 may be coupled with the support structure to apply a downforce against the seal body 302. For example, slit 408 may be positioned about upper flange 518a of one of the I-beams 517, with fastener 410 and/or pin 412 being used to secure downforce mechanism 400 in position relative to I-beam 517. Bolt 420 may be tightened to press insulating button 422 against upper surface 307 of seal body 302 to apply downward force to electrode seal 300 to compress bottom sealing element 350 between bottom surface 309 and the upper surface of precast ring 513. Any number of downforce mechanisms 400 may be interfaced with electrode seal 300. For example, each electrode seal 300 may be contacted by two or more downforce mechanisms 400, three or more downforce mechanisms 400, four or more downforce mechanisms 400, five or more downforce mechanisms 400, six or more downforce mechanisms 400, or more. Downforce mechanisms 400 may be positioned at regular or irregular azimuthal intervals about electrode seal 300. In a particular embodiment, two downforce mechanisms 400 may be positioned substantially opposite one another, such as by being between 170 degrees and 190 degrees apart, 175 degrees and 185 degrees apart, or 180 degrees apart from one another. Positioning two downforce mechanisms 400 substantially opposite one another may enable both downforce mechanisms 400 to be accessible even when spacing between adjacent electrode stacks is small, such as described in relation to FIG. 2.

In some embodiments, metallurgical system 500 may include an inert gas source 580 that may deliver a supply of an inert gas, such as argon, to the volume between electrode seal 300 and electrode stack 540. For example, one or more fluid lines 585 may extend between and fluidly couple inert gas source 580 and electrode seal 300, such as via gas injection ports 370. The inert gas may be delivered to a space between upper sealing element 330 and lower sealing element 340 and may saturate the volume between electrode seal 300 and electrode stack 540. The inert gas may be flowed from inert gas source 580 in various manners. For example, inert gas source 580 may continuously flow the inert gas into the volume at a constant rate. In other embodiments, inert gas source 580 may flow the inert gas based on a pressure within the volume. For example, when the pressure exceeds a predetermined threshold, the flow of inert gas may be reduced or halted until the pressure falls under the threshold pressure. In some embodiments, the inert gas may be flowed when a pressure within the volume falls below a threshold pressure. For example, pressure below a certain level may indicate that the volume is not saturated with the inert gas and/or that there is a leak in the interface between electrode seal 300 and the lid, which may draw the inert gas into refractory vessel 510. Refractory vessel 510 is often maintained at a negative pressure to prevent any gases and/or other byproducts of the metallurgical operations from escaping from the refractory vessel at any positions other than exhaust lines. As a result of the negative pressure within refractory vessel 510, any leaks in electrode seal 300 (such as during sliding of electrode stack 540 within electrode seal 300) may result in the negative pressure drawing in the inert gas, rather than outside air that could otherwise lead to air burn of electrode stack 540.

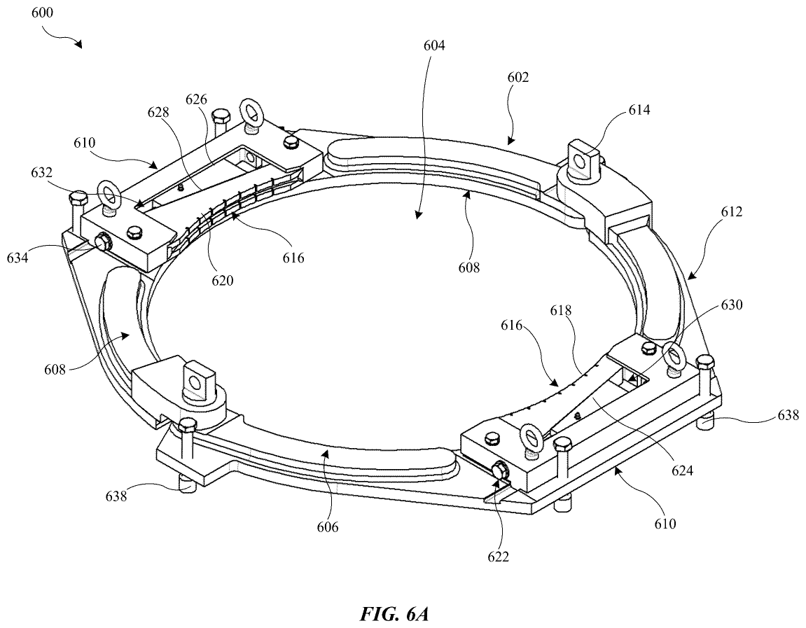

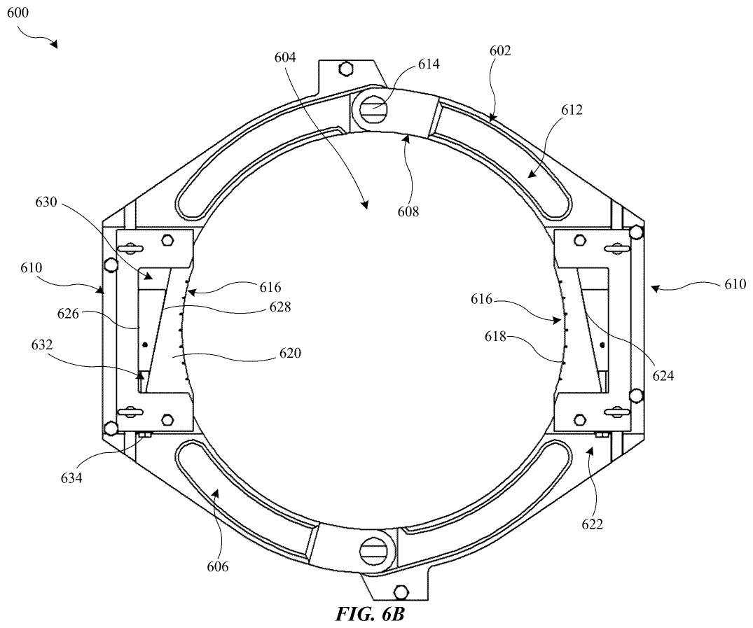

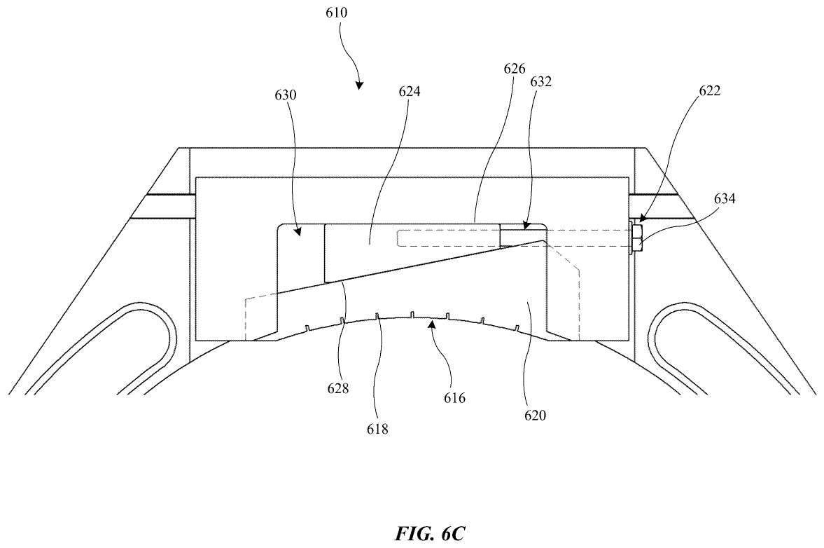

FIGS. 6A-6C illustrate one embodiment of a lower electrode clamp or electrode clamp 600 that may be used in a metallurgical system. For example, electrode clamp 600 may be used in metallurgical system 100, such as for electrode clamp 180 and/or as another clamp that may be engaged with at least one surface of an electrode segment. Electrode clamp 600 may include a clamp body 602 that defines an open interior 604. For example, clamp body 602 may include an inner surface 606 having a diameter that defines open interior 604. Open interior 604 may be circular in shape and may be sized to receive an electrode segment, such as electrode segment 142. For example, open interior 604 may have a diameter that is slightly larger than a diameter of the electrode segment to be received in open interior 604. In some embodiments, the diameter of open interior 604 may be greater than the diameter of the electrode segment by between or about 0.1% and 5%, between or about 0.25% and 2.5%, or between or about 0.5% and 1%, although other values are possible in various embodiments. In other embodiments, open interior 604 may be non-circular in shape.

In some embodiments, clamp body 602 may be formed as a single component that may be slid and/or otherwise positioned about an electrode segment. In other embodiments, clamp body 602 may be formed from two or more body pieces 608 that may be joined to form clamp body 602. For example, each body piece 608 may be semi-annular and/or otherwise define an arc-shaped portion of inner surface 606, although other shapes for each portion of inner surface 606 are possible in embodiments in which open interior 604 has a non-circular shape. As illustrated, clamp body 602 includes two body pieces 608 that may be joined to form clamp body 602, with each body piece 608 defining a semicircular portion of inner surface 606. It will be appreciated that greater numbers of body pieces 608 may be utilized to form clamp body 602 in some embodiments, and that a size and/or shape of each body piece 608 may be the same or different in various embodiments. Each body piece 608 may have any shape. As illustrated, each body piece 608 is generally C-shaped, with a central block portion 610 that includes arc-shaped segments 612 on opposing sides of central block portion 610.

When multiple body pieces 608 are utilized, the body pieces 608 may be permanently and/or reversibly coupled together to form clamp body 602. For example, one or more of the body pieces 608 may be adhered, welded, and/or otherwise coupled with the intention that the coupling will not be reversed. In some embodiments, one or more of the body pieces 608 may be reversibly coupled, such as using pins, magnets, fasteners, latches, and/or other coupling techniques. As illustrated, one or more pins 614 may be used to couple ends of adjacent body pieces 608. For example, each end of each body piece 608 may define one or more apertures that extend at least partially through a thickness of the respective body piece 608. Pins 614 may be inserted and secured within each aperture or recess, which may couple the two body pieces 608 together. Additionally, if the pins 614 are removed at one azimuthal position, the adjacent body pieces 608 may pivot and/or rotate relative to one another about a remaining pin 614.

Electrode clamp 600 may include one or more clamping surfaces 616. Each clamping surface 616 may be laterally moveable relative to inner surface 606, such as to engage and/or disengage with a surface of an electrode segment received within open interior 604. Where multiple clamping surfaces 616 are utilized, each clamping surface 616 may be positioned at a different azimuthal position of clamp body 602, which may enable electrode clamp 600 to engage one or more surfaces of the electrode segment at different angular positions. In some embodiments, clamping surfaces 616 may be arranged at regular intervals (e.g., every 180 degrees, every 120 degrees, every 90 degrees, every 72 degrees, every 60 degrees, etc.), which may help keep a net clamping force applied by electrode clamp 600 to be approximately centered about a longitudinal axis of the electrode segment when each clamping surface 616 is tightened to a same degree. It will be appreciated that clamping surfaces 616 may be at irregular intervals in some embodiments. As illustrated, electrode clamp 600 includes two clamping surfaces 616, with each clamping surface 616 being movably coupled to one of the central block portions 610.

Each clamping surface 616 may have any shape and/or size that enables the clamping surfaces 616 to collectively apply a sufficient amount of force to the electrode segment to inhibit axial movement of the electrode stack and attached stem assembly, while not applying so much pressure to the electrode segment to crack or otherwise damage the electrode segment (although some small amount of indentation of the electrode segment may be desired to enhance the clamping of the electrode segment). For example, in some embodiments, the clamping surfaces 616 of electrode clamp 600 may collectively apply between about 8500 N and 270000 N of force, depending on a size of the electrode stacks used. A size and shape of each clamping surface 616 may be selected such that a pressure applied at each clamping surface 616 does not exceed about 50 MPa. In a particular embodiment, each clamping surface 616 may be arc-shaped. For example, a radius of the arc-shape may be selected to substantially match a radius of the electrode segment. For example, the radius of the arc-shape may be between about 95% and 105% of a radius of the electrode segment in some embodiments. In some embodiments, each clamping surface 616 may be relatively smooth and continuous. However, in other embodiments, each clamping surface 616 may include one or more features that enable greater pressure to be applied. For example, in the illustrated embodiment, each clamping surface 616 includes a number of serrations 618 that divide each clamping surface 616 into smaller sections that may each bite into a surface of the electrode segment. As illustrated, the serrations 618 are arranged in two rows that extend along a length of each clamping surface 616, however other arrangements (such as more or fewer rows) and/or types of gripping features may be utilized in various embodiments. Each clamping surface 616 may extend about a portion of the open interior 604. For example, in some embodiments each clamping surface 616 may extend around between 5 degrees and 45 degrees of the open interior 604, between 10 degrees and 40 degrees of the open interior 604, between 15 degrees and 35 degrees of the open interior 604, or between 20 degrees and 30 degrees of the open interior 604.

In some embodiments, each clamping surface 616 may be disposed on an inward side of a cleat 620 that is coupled to clamp body 602. Cleat 620 may be disposed within a channel or otherwise secured to clamp body 602 to permit lateral movement of cleat 620 relative to clamp body 602. As best illustrated in FIG. 6C, cleat 620 may include a body that tapers along a length of cleat 620 such that a first end of cleat 620 is narrower than an opposite second end of cleat 620. For example, an outward surface of cleat 620 opposite clamping surface 616 may be angled relative to clamping surface 616 and may result in cleat 620 being generally wedge-shaped.

Electrode clamp 600 may include a tightening mechanism 622 that is operably coupled to one or more of the clamping surfaces 616 and/or cleats 620. Each tightening mechanism 622 may be configured to adjust a lateral position of clamping surface 616 and/or cleat 620 relative to clamp body 602, which may cause a corresponding adjustment of a clamping force applied by electrode clamp 600 on the electrode segment. In some embodiments, a single tightening mechanism 622 may adjust the lateral position of all clamping surfaces 616 and/or cleats 620, while in other embodiments each tightening mechanism 622 may adjust the lateral position of only a subset (which could be one) of the clamping surfaces 616 and/or cleats 620 on electrode clamp 600. For example, as illustrated each clamping surface 616 and cleat 620 includes a dedicated tightening mechanism 622.

In some embodiments, each tightening mechanism 622 may be or include a linear actuator that may linearly push cleat 620 and clamping surface 616 inward relative to clamp body 602 when tightening mechanism 622 is tightened. In other embodiments, non-linear actuators may be used. As illustrated, tightening mechanism 622 includes a wedge body 624 that is movable within a channel. Movement of wedge body 624 may be in a direction that is at least substantially orthogonal (e.g., between 75 degrees and 105 degrees) relative to movement of cleat 620. For example, in some embodiments, the channel may have an outer wall that is substantially orthogonal to movement of cleat 620. An outer surface 626 of wedge body 624 may abut the outer wall of the channel, while an inner surface 628 of wedge body 624 may be positioned against the radially outward surface of cleat 620. Inner surface 628 may be angled relative to outer surface 626. Inner surface 628 may taper in an opposite direction as the outward surface of cleat 620 such that when wedge body 624 is moved toward a distal end 630 of the channel, a thin portion of cleat 620 is aligned with a thick portion of wedge body 624 and when wedge body 624 is moved toward a proximal end 632 of the channel, a thick portion of cleat 620 is aligned with the thick portion of wedge body 624. Outer surface 626 of wedge body 624 abuts and is constrained by the outer wall of the channel while cleat 620 is unconstrained in an inward direction relative to clamp body 602. Thus, as wedge body 624 moves axially within the channel, the angled inner surface 628 of wedge body 624 moves relative to the angled outward surface of cleat 620 to change a maximum collective thickness of cleat 620 and wedge body 624 and applies a lateral force to the angled outward surface of cleat 620 to adjust a lateral position of clamping surface 616 relative to inner surface 606 of clamp body 602. For example, as wedge body 624 is moved toward distal end 630, cleat 620 is permitted to move radially outward relative to clamp body 602 and the lateral force applied to cleat 620 (and an electrode segment positioned within open interior 604) is reduced. Similarly, as wedge body 624 is moved toward proximal end 632, cleat 620 is forced to move inward relative to clamp body 602 and the lateral force applied to cleat 620 (and an electrode segment positioned within open interior 604) is increased.

In some embodiments, to adjust the position of wedge body 624, tightening mechanism 622 may include an adjustment member, such as a screw 634 or other threaded member that is coupled to wedge body 624. In some embodiments, screw 634 may be fixed in place relative to clamp body 602 such that rotation of screw 634 does not result in a head of screw 634 moving axially relative to clamp body 602. For example, screw 634 may be engaged with a threaded recess formed through a proximal or distal end of wedge body 624 and may extend through a portion of clamp body 602. As illustrated, screw 634 is engaged with a threaded recess formed in the proximal end (e.g., the narrow end) of wedge body 624. As screw 634 is rotated in a first direction, the engagement of threads of screw 634 and the threaded recess forces wedge body 624 to move toward the distal end of the channel to decrease the inward force applied by cleat 620 and clamping surface 616. As screw 634 is rotated in an opposite second direction, the engagement of threads of screw 634 and the threaded recess forces wedge body 624 to move toward the proximal end of the channel to increase the inward force applied by cleat 620 and clamping surface 616. In other embodiments, screw 634 may be fixed in position relative to wedge body 624 such that rotation of screw 634 moves the head of screw 634 (and wedge body 624) axially relative to clamp body 602.

In some embodiments, the cleat 620 may be biased in an inward or outward direction relative to open interior 604. For example, one or more compression springs may be positioned to apply an outward biasing force against cleat 620. The outward force may push an outer surface of cleat 620 against angled inner surface 628 of wedge body 624 to retract wedge body 624 when tightening mechanism 622 is loosened. This enables cleat 620 to be actively retracted from open interior 604 when loosened to enable electrode clamp 600 to be disengaged from an electrode received within open interior 604.

The adjustment members (e.g., screw 634) of each tightening mechanism 622 may be positioned at various azimuthal locations about clamp body 602. The adjustment members may be positioned at equal intervals about clamp body 602. In some embodiments, the adjustment members may be positioned to improve access to the adjustment members. For example, in embodiments in which multiple electrode stacks are provided within a refractory vessel, with small gaps between adjacent electrode stacks (such as described in relation to FIG. 2), it may be difficult to access adjustment members that are positioned on a portion of an electrode stack that faces a center of the refractory vessel due to the presence of one or more electrode stacks on either side and/or a rear of the electrode stack. Various techniques may be utilized to ensure that the adjustment members are readily accessible, even in metallurgical systems that have tight spacing between adjacent electrode stacks. For example, in some embodiments the adjustment members may be oriented in a same direction relative to clamp body 602. As just one example, a head of each screw 634 may be positioned on a same half or side of clamp body 602, with each screw 634 being substantially parallel (e.g., within 20 degrees of parallel). The heads of screws 634 may be positioned in an outer region of clamp body 602 and the electrode segment, such as an outer degrees (e.g., relative to a center of the refractory vessel) 220 degrees, outer 200 degrees, outer 180 degrees, or less. Such positioning and orientation of screws 634 may ensure that the adjustment member of each tightening mechanism 622 is accessible from a single side of the electrode and may make it quicker and easier for the tightening mechanism 622 to be loosened and tightened to engage and disengage the electrode clamp 600 from the electrode segment, even when a distance between adjacent electrode stacks is too small for a human technician to access.

Electrode clamp 600 may be designed to sit atop a support structure (such as a lid, I-beam, and/or other support structure) of a metallurgical system. In some embodiments, it may be desirable to electrically isolate the support structure from electrode clamp 600 and the electrode stack. In such embodiments, one or more electrical isolators may be interfaced between electrode clamp 600 and the support structure. For example, in some embodiments an electrically insulating material (e.g., a coating, layer of insulating material such as a ceramic or polymer, etc.) may be disposed on the upward-facing surface of the support structure. In a particular embodiment, the electrically insulating material may include polyamide-imide engineered thermoplastic or other ceramic material. As just one example, electrode clamp 600 may include at least one electrically insulating base member 638 coupled to a bottom surface of clamp body 602. For example, in the illustrated embodiment electrode clamp 600 includes multiple electrically insulating base members 638 that extend downward from a bottom surface of clamp body 602, although in some embodiments electrically insulating base members 638 may be positioned at other locations relative to clamp body 602. In some embodiments, the electrically insulating base members 638 may be in the form of electrically insulating feet that directly contact a surface of the support structure. Each electrically insulating base member 638 may separate electrically conductive materials of electrode clamp 600 from the support structure to electrically isolate electrode clamp 600 from the support structure. Each electrically insulating base member 638 may be formed from any electrically insulating material, such as ceramic and/or polymeric materials. In a particular embodiment, each electrically insulating base member 638 may be formed from a polyether ether ketone (PEEK) material. The material may be selected to have a softening point that is at least 500° C., at least 550° C., at least 600° C., at least 650° C., at least 700° C., at least 750° C., at least 800° C., at least 850° C., at least 900° C., at least 950° C., at least 1000° C., or greater. Materials with softening points at these levels may better withstand the operating temperatures of metallurgical systems. The softening point may be measured using any number of techniques such as, but not limited to, the ring and ball method (e.g., American Society for Testing and Materials (ASTM) D 3461-76), the Krämer-Sarnow method (e.g., Deutsches Institut für Normung (DIN) 53 180), the Mettler softening point method (e.g., ASTM D 3461-76), and/or the plate-plate stress rheometer test.

Electrically insulating base members 638 may be positioned at different azimuthal locations about clamp body 602. A number, size, and arrangement of electrically insulating base members 638 may be selected to ensure that electrode clamp 600 may support the weight of the electrode stack and stem assembly without permitting axial movement of the electrode stack and stem assembly when clamping surfaces 616 of electrode clamp 600 are engaged with the electrode stack. In some embodiments, electrically insulating base members 638 may be provided at regular or irregular angular intervals about clamp body 602. As illustrated, each central block portion 610 includes a two electrically insulating base members 638, while a portion of clamp body 602 proximate each pin 614 includes an electrically insulating base member 638. It will be appreciated that numerous configurations of electrically insulating base members 638 exist.

In some embodiments, electrode clamp 600 may be sized to with a small footprint relative to the electrode segment about which electrode clamp 600 is positioned. For example, as noted above metallurgical systems having a number of different electrode stacks may have small distances between adjacent electrode stacks to help minimize heat loss within the metallurgical system. The tight spacing between adjacent electrode stacks may limit the space available to interface electrode clamp 600 with the electrode stack and/or otherwise interact with electrode clamp 600 (such as to engage/disengage clamping surface 616 with a surface of the electrode segment). Therefore, in some embodiments, electrode clamp 600 may extend from the peripheral surface of the electrode segment by a distance of no more than 20% of a diameter of the electrode segment, no more than 15%, no more than 10%, no more than 5%, or less. In some embodiments, the maximum distance electrode clamp 600 may extend from the peripheral surface of the electrode segment may be no more than 6 inches, no more than 5 inches, no more than 4 inches, no more than 3 inches, no more than 2 inches, no more than 1 inch, or less.

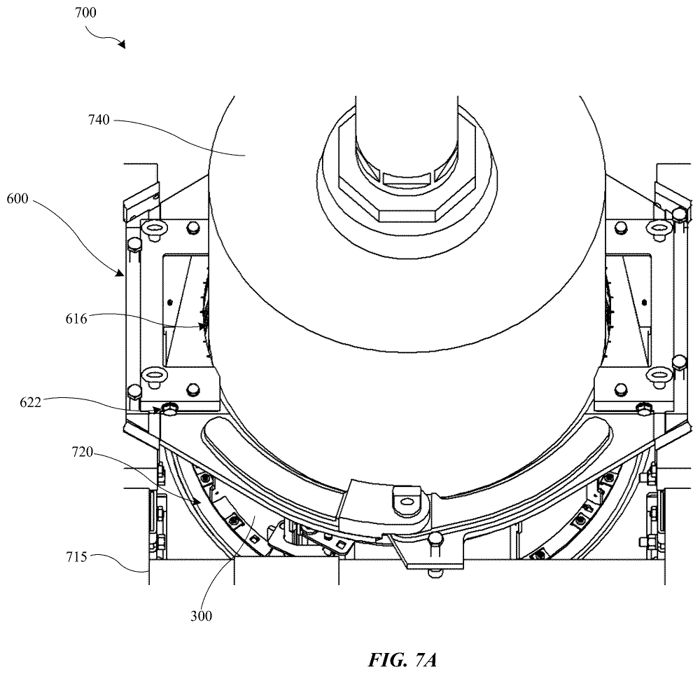

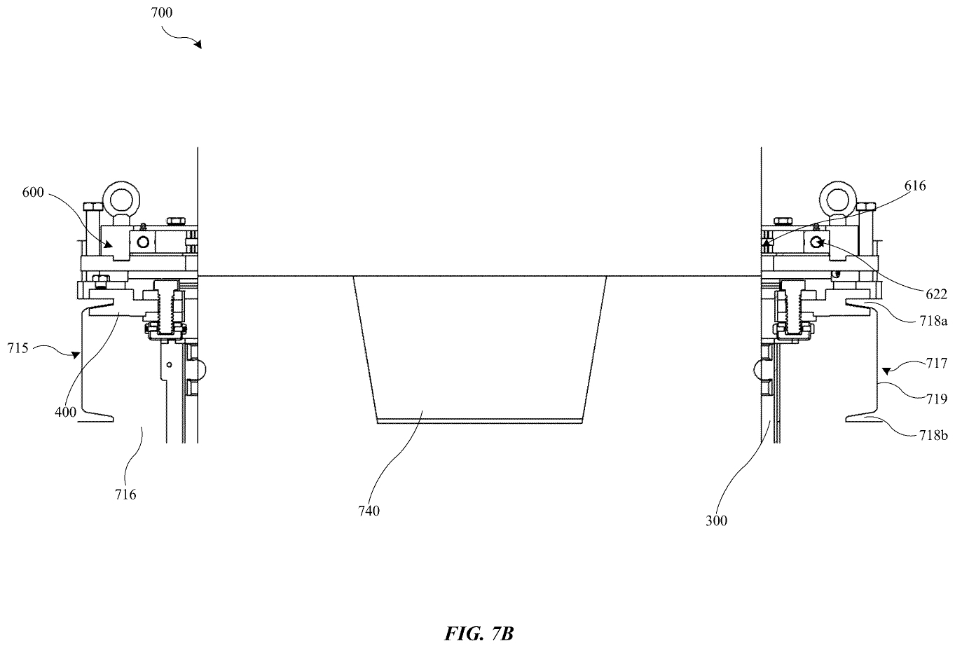

FIGS. 7A and 7B illustrate a portion of a metallurgical system 700. Metallurgical system 700 may be similar to metallurgical system 100 and may include any of the features described in relation to metallurgical systems 100, 200, 500, and other metallurgical systems described herein. As illustrated, metallurgical system 700 may include a refractory vessel, which may be similar to refractory vessels 110 and 210. A lid 720 may be seated directly and/or indirectly atop refractory vessel and may define one or more apertures that may each receive an electrode stack 740 (which may be similar to electrode stack 140), which may at least partially extend into the refractory vessel. An electrode seal, such as gas seal 130 or electrode seal 300 may be seated atop lid 720 to seal the interface between electrode stack 740 and lid 720. A support structure 715 may be seated atop lid 720 and may be positioned laterally outward from a peripheral surface of the electrode stack 740. In some embodiments, support structure 715 may form all or a part of a top of the refractory vessel. For example, support structure 715 may be or include lid 720 in some embodiments. In other embodiments, support structure 715 may include components seated atop lid 720. Support structure 715 may include one or more blocks 716 that are positioned atop lid 720 and that may support a number of I-beams 717 or other structural members that may extend about all or a portion of an opening formed within lid 710. Each I-beam 717 may include two flanges 718 that are separated by a web 719. An upper flange 718a may extend above and be vertically spaced apart from a top surface of blocks 716, while a lower flange 718b may be embedded within blocks 716 in some embodiments. A number of downforce mechanisms 400 may be coupled to support structure 715, such as with a slit (e.g., slit 408) receiving upper flange 718a to vertically fix downforce mechanism 400. Each downforce mechanism 400 may contact an upper surface (e.g., upper surface 307) of electrode seal 300 to compress a bottom sealing element (e.g., bottom sealing element 300) between electrode seal 300 and lid 720.

Electrode clamp 600 may be positioned above electrode seal 300 and about electrode stack 740. Electrode clamp 600 may be seated atop lid 720 and/or support structure 715. For example, as illustrated, electrically insulating base members 638 are seated atop upper flange 718a of I-beams 717 to support and electrically isolate electrode clamp 600 from support structure 715 and lid 720. Clamping surfaces 616 of electrode clamp 600 may be tightened and loosened against electrode stack 740 to permit or inhibit axial motion of electrode stack 740.

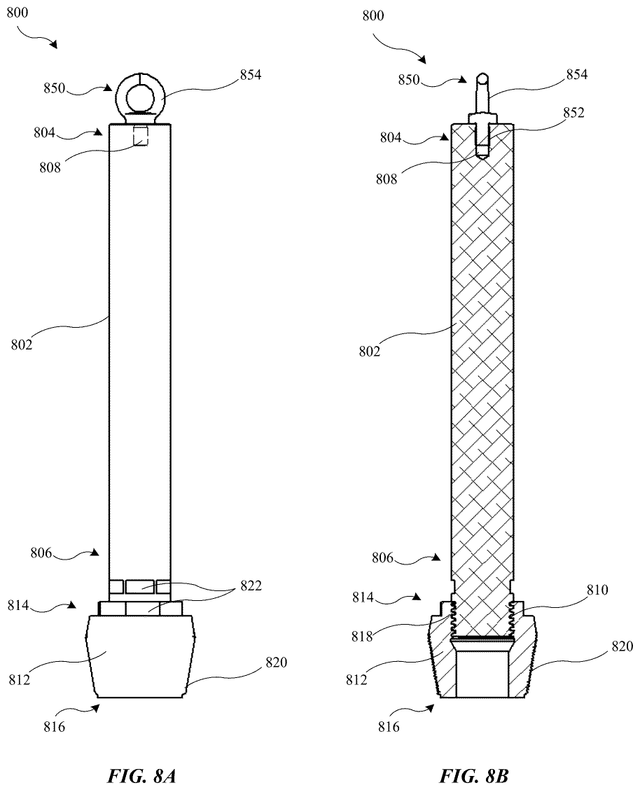

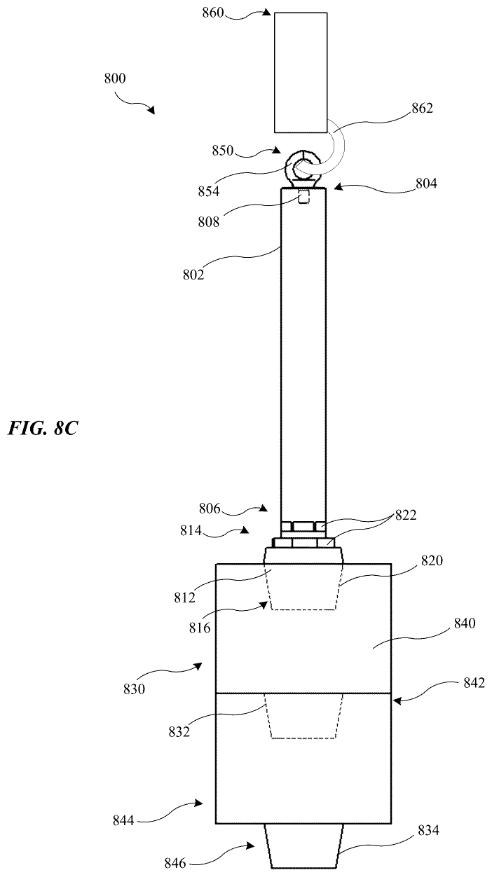

FIGS. 8A-8C illustrate an embodiment of an electrode stem assembly 800. Stem assembly 800 may be used in metallurgical system 100, such as for stem assembly 173 and may include any feature described in relation to stem assembly 173. Stem assembly 800 may include a stem 802 that may include a first end 804 and a second end 806 spaced apart from first end 804. First end 804 may include a first connector 808 and second end 806 may include a second connector 810. In some embodiments, first connector 808 and/or second connector 810 may be a threaded connector, although other types of connectors, such as snap fit, quick connect-disconnect, and/or other mechanical connectors. As illustrated, first connector 808 is a female threaded connector that is formed in a distal end surface of first end 804, while second connector 810 is a male threaded connector formed about a peripheral surface of second end 806, although other configurations are possible.

Stem 802 may be formed from a material that has an electrical conductivity of at least 5.0×10⁶ siemens/m, at least 5.9×10⁶ siemens/m, at least 7.5×10⁶ siemens/m, at least 1×10⁷ siemens/m, at least 1.25×10⁷ siemens/m, at least 1.5×10⁷ siemens/m, at least 1.75×10⁷ siemens/m, at least 2×10⁷ siemens/m, at least 2.25×10⁷ siemens/m, at least 2.5×10⁷ siemens/m, at least 2.75×10⁷ siemens/m, at least 3×10⁷ siemens/m, or more. By having an electrical conductivity at these levels, stem 802 may carry sufficient current density to efficiently perform metallurgical operations, such as MOE. In some embodiments, stem 802 may be formed from aluminum, copper, silver, and/or alloys thereof, although other materials are possible in some embodiments. In some embodiments, stem 802 may be formed from a single material, while in other embodiments, stem 802 may be formed from one or more alloys that may include one or more multiple conductive materials. In a particular embodiment, stem 802 may include a core and a sheath that are formed from different materials. As just one example, the core may be formed from a copper alloy, while the sheath may be formed from an aluminum alloy. It will be appreciated that other configurations of stem 802 are possible in various embodiments.

Stem assembly 800 may include an electrode connector 812. Electrode connector 812 may include a first end 814 and a second end 816 spaced apart from first end 814. First end 814 may include a first connector 818 and second end 816 may include a second connector 820. In some embodiments, first connector 818 and/or second connector 820 may be a threaded connector, although other types of connectors, such as snap fit, quick connect-disconnect, clamps, and/or other mechanical connectors. As illustrated, first connector 818 is a female threaded connector that is formed in a distal end surface of first end 814, while second connector 820 is a male threaded connector formed about a peripheral surface of second end 816, although other configurations are possible.

Stem 802 and electrode coupler 812 may be reversibly coupled together, which may enable electrode coupler 812 to couple stem 802 to an electrode stack 830 as illustrated in FIG. 8C, which may be similar to electrode stack 140. For example, in the illustrated embodiment second connector 810 of stem 802 is engaged with first connector 818 of electrode coupler 812. For example, second connector 810 of stem 802 may be a male threaded connector that is inserted within and engaged with threads of first connector 818 of electrode coupler 812. In some embodiments in which a threaded connection is used to secure stem 802 and electrode coupler 812 together, peripheral surfaces of one or both of stem 802 and electrode coupler 812 may have a non-circular cross-section, such as by defining one or more flat surfaces and/or otherwise non-circular surfaces that may be engaged by a tool, such as a wrench, to help tighten and/or loosen the threaded connection. For example, as illustrated in FIG. 8A, one or more wrench flats 822 are formed into first end 814 of electrode coupler 812 and second end 806 of stem 802 that enable a wrench or other tool to rotate the stem 802 and electrode coupler 812 relative to one another to tighten and loosen the components.

As noted above, electrode coupler 812 may be used to couple stem 802 with an electrode stack 830. For example, as illustrated in FIG. 8C, each electrode segment 840 of electrode stack 830 may include a first connector 832 that is configured to mate with second connector 820 of electrode coupler 812. For example, where second connector 820 of electrode coupler 812 is a threaded connector, first connector 832 of electrode may be formed as a corresponding threaded connector formed at an upper end of each electrode segment 840. As illustrated, second connector 820 of electrode coupler 812 is a male threaded connector that is insertable and engageable with threads of a female connector formed within a top surface of electrode segment 840. While discussed as using threaded connectors to couple electrode segment 840 and electrode coupler 812, it will be appreciated that other forms of reversible connections may be used in various embodiments.

By utilizing reversible connections, embodiments may enable stem assembly 800 from being removed from electrode stack 830. This may enable stem assembly 800 to be reused with a different electrode segment 840 after new electrode segments 840 have been added to electrode stack 830 as discussed in greater detail below. The reversible coupling of electrode stack 830 and electrode coupler 812 may also facilitate the additional of new electrode segments 840 to electrode stack 830, which may be done while a metallurgical system is operational and/or during downtime of the metallurgical system.

As illustrated, electrode stack 830 includes a number of electrode segments 840 that are coupled to one another end to end. Each electrode segment 840 within electrode stack 830 may include a top end 842 and a bottom end 844. Top end 842 may include or define first connector 832, while bottom end 844 may define or include a second connector 834. For example, each of first connector 832 and second connector 834 may include a threaded connector, with one of first connector 832 and second connector 834 being a male threaded connector and the other of first connector 832 and second connector 834 being a female threaded connector. As illustrated, first connector 832 is a female threaded connector formed in an upper surface of top end 842, while second connector 834 is in the form of a male threaded connector that is formed on a protrusion 846 that extends from a lower surface of bottom end 844 (although this orientation may be reversed in some embodiments, or other reversible couplings may be utilized). First connector 832 and second connector 834 may be sized and shaped to engage with one another. For example, the protrusion 846 may be sized and shaped substantially match a size and shape of a receptacle of the female threaded connection of first connector 832, with threads of each of first connector 832 and second connector 834 having a compatible pitch, major diameter, and thread angle. Such a connector design for first connector 832 and second connector 834 may enable second connector 834 of one electrode segment 840 to be reversibly coupled with first connector 832 of another electrode segment 840 to create electrode stack 830. Any number of electrode segments 840 may be coupled together end to end in such a manner to create electrode stacks of various lengths. This design may also enable new electrode segments 840 to be added to electrode stack 830 as part of a continuous feed process as will be discussed in greater detail below.

As first connector 832 of each electrode segment 840 may, at different times, be coupled to second connector 820 of electrode coupler 812 (e.g., to couple electrode stack 830 to stem assembly 800) and second connector 834 of another electrode segment 840 (e.g., to increase a length of the electrode stack), second connector 834 of electrode segment 840 and second connector 820 of electrode coupler 812 may have a similar or same structure. For example, in the illustrated embodiment second connector 834 of electrode segment 840 and second connector 820 of electrode coupler 812 are each in the form of a male threaded connector, with second connector 834 of electrode segment 840 and second connector 820 of electrode coupler 812 being of identical or similar (e.g., within 10%, within 5%, within 3%, within 1%, or less) size and a same general shape. For example, as illustrated, each second connector 834 of electrode segment 840 and second connector 820 of electrode coupler 812 taper from a wide base to a narrower distal end. First connector 832 of each electrode segment 840 may include a receptacle formed in an upper surface of electrode segment 840 that has a corresponding taper (e.g., wider at the upper surface and narrower at a base of the receptacle) to mate with second connector 834 of electrode segment 840 or second connector 820 of electrode coupler 812. It will be appreciated that other shapes are possible. For example, in some embodiments each of second connector 820 of electrode coupler 812, first connector 832 of each electrode segment 840, and second connector 832 of each electrode segment 840 may have a cylindrical shape with a constant diameter.

In some embodiments, stem assembly 800 may omit electrode coupler 812, with stem 802 being sized and shaped to be directly couplable to electrode stack 830. However, electrode coupler 812 may help accommodate mismatches in the coefficient of thermal expansion (CTE) between electrode stack 830 and stem 802. As noted above, stem 802 may be selected from an electrically conductive material that is suitable to efficiently carry a current density per area of between about 0.5 A/cm² and 1.5 A/cm². Suitable materials for stem 802 may have a significantly greater CTE (e.g., on the order of 2.5×10⁻⁵/° C.) than electrode stack 830, which may be made of a baked carbon (such as graphite) having a CTE on the order of 1.5×10⁻⁶/° C. or less. To provide an intermediate interface between stem 802 and electrode stack 830, electrode coupler 812 may be formed from a material that has a CTE that is closer to that of electrode stack 830, as electrode stack 830 is typically more brittle than stem 802 and more likely to fail from thermal mismatch during high temperature metallurgical operations. In a particular embodiment, electrode coupler 812 may be formed from a material that has a CTE that is lower than that of stem 802 and higher than that of electrode stack 830. In some embodiments, a ratio of the CTE of electrode coupler 812 and a CTE of electrode stack 830 is less than about 5:1. For example, electrode coupler 812 may have a CTE of less than or equal to 7.5×10⁻⁶/° C., less than or equal to 7.0×10⁻⁶/° C., less than or equal to 6.5×10⁻⁶/° C., less than or equal to 6.0×10⁻⁶/° C., less than or equal to 5.5×10⁻⁶/° C., less than or equal to 5.0×10⁻⁶/° C., less than or equal to 4.5×10⁻⁶/° C., less than or equal to 4.0×10⁻⁶/° C., less than or equal to 3.5×10⁻⁶/° C., less than or equal to 3×10⁻⁶/° C., or less. In some embodiments, electrode coupler 812 may be formed from a nickel cast iron alloy, although other materials having sufficiently low CTE and strength to hold the weight of electrode stack 830 are possible.

In some embodiments, first connector 808 of stem 802 may be or may be coupled to an eyelet 850 or hook. Eyelet 850 may extend upward beyond first end 804 of stem 802 and may provide a grasping location for a tool that may be used to move and/or otherwise manipulate stem assembly 800 and/or electrode stack 830. For example, as illustrated in FIG. 8C, a crane 860 or other tool may include a grasping mechanism 862 (such as a hook) that may be inserted within an opening of eyelet 850 and/or otherwise grasp a portion of eyelet 850 to enable the crane 860 to transport stem assembly 800 (and possible an electrode segment 840 and/or electrode stack 830) to or from a support structure (such as support structure 165) of a metallurgical system (such as metallurgical systems 100, 200, 500, and 700). Additionally, crane 860 may grasp eyelet 850 to rotate stem assembly 800 to engage or disengage electrode coupler 812 and electrode stack 830 and/or to couple two electrode segments 840 together.

In some embodiments, eyelet 850 may be a single piece component, while in other embodiments, two or more pieces may be coupled together to form eyelet 850. For example, eyelet 850 may include a connector portion 852 that may be engaged with first connector 808 of stem 802 and an eyelet portion 854 that may protrude above first end 804 of stem 802 to provide the grasping location for crane 860 or other tool. In some embodiments, first connector 808 of stem 802 and connector portion 852 may each be threaded connectors. For example, as illustrated first connector 808 of stem 802 is a female threaded receptacle that is formed in an upper surface of first end 804, while connector portion 852 of eyelet 850 is a male threaded protrusion that extends downward from eyelet portion 854. It will be appreciated that the threaded connectors may be reversed and/or other mechanical connectors may be used to coupled eyelet 850 and stem 802 in various embodiments. The coupling of connector portion 854 and first connector 808 may be permanent or reversible in various embodiments. In some embodiments, connector portion 852 and eyelet portion 854 may be fixed relative to one another, while in other embodiments connector portion 852 and eyelet portion 854 may be rotatable relative to one another.

In some embodiments, the grasping mechanism 862 and/or eyelet 850 may be formed from and/or otherwise include an electrically insulating material, such as a ceramic, a polymeric material, and/or other electrically isolating material. For example, eyelet portion 854 and/or connector portion 852 may be formed from an electrically insulating material and/or eyelet portion may be coated or covered with an electrically insulating material. The use of electrically insulating materials may enable crane 860 and/or other tool to be electrically isolated from stem assembly 800 such that current passing through stem assembly 800 during metallurgical processing operations does not pass through crane 860 when grasping mechanism 862 engages eyelet 850 while stem assembly 800 is still coupled with a busbar or other current source of a metallurgical system. The electrical isolation of crane 860 may enable additional electrode segments 840 to be added to the electrode stack while metallurgical system remains in an operational state.

In some embodiments, eyelet 850 may be integrally formed with stem 802, rather than being a separate component. For example, first connector 808 may be formed as an eyelet that extends from an upper surface of first end 804 of stem 800. Stem 802 and eyelet 850 may be cast, forged, and/or otherwise formed as a monolithic component formed of a conductive material. In such embodiments, eyelet 850 may include only eyelet portion 854 and may omit connector portion 852. Electrically insulating material may be positioned about eyelet portion 854 in some embodiments.

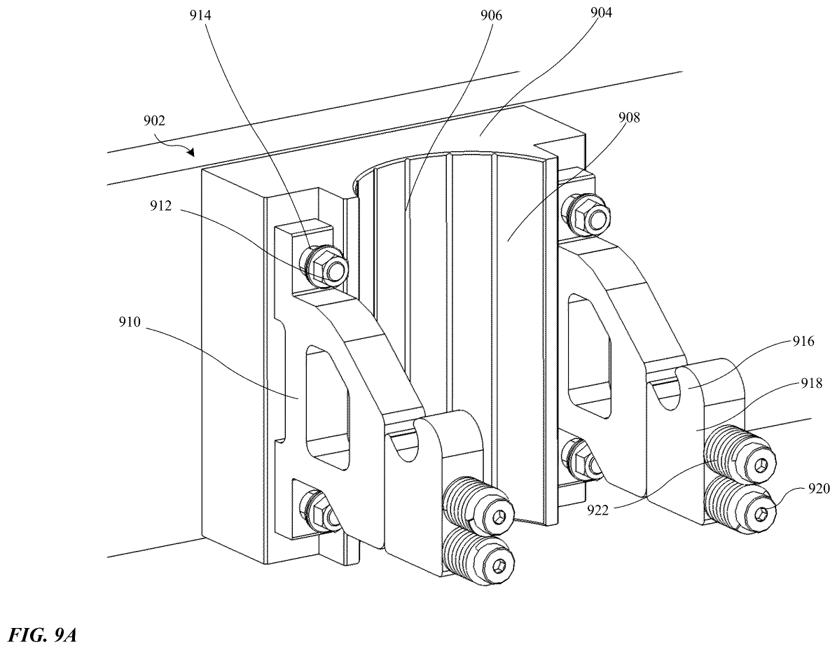

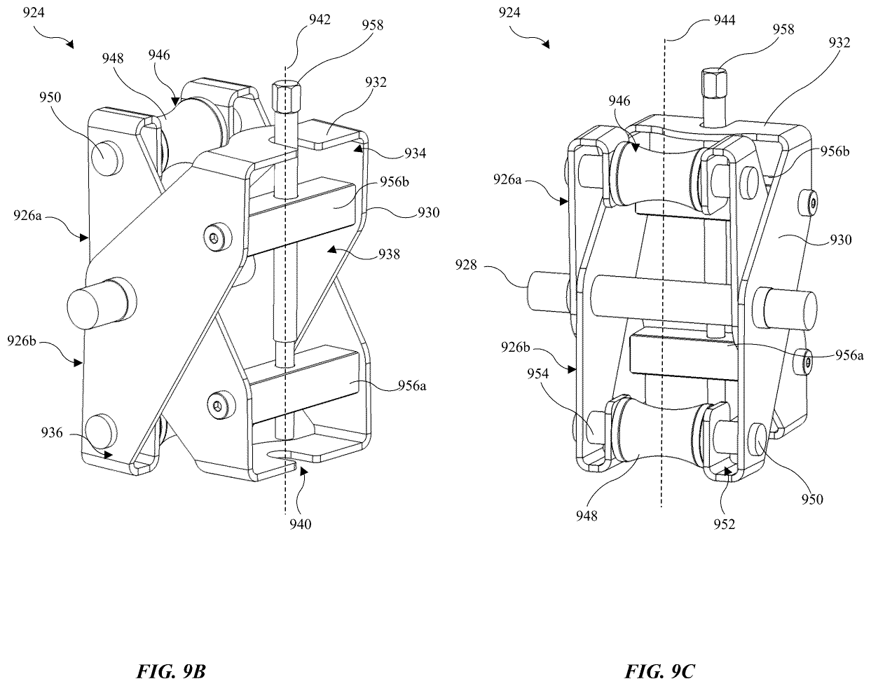

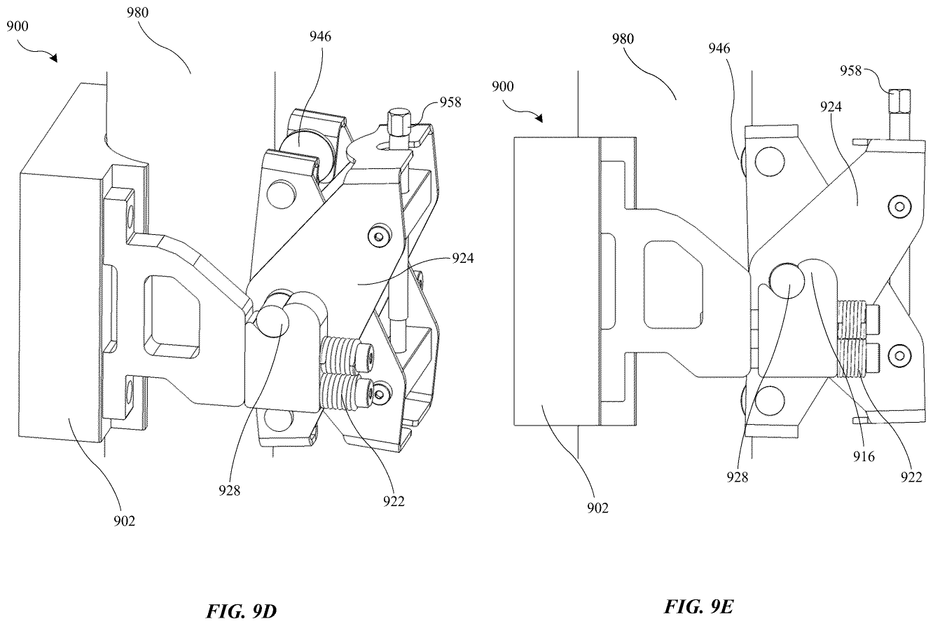

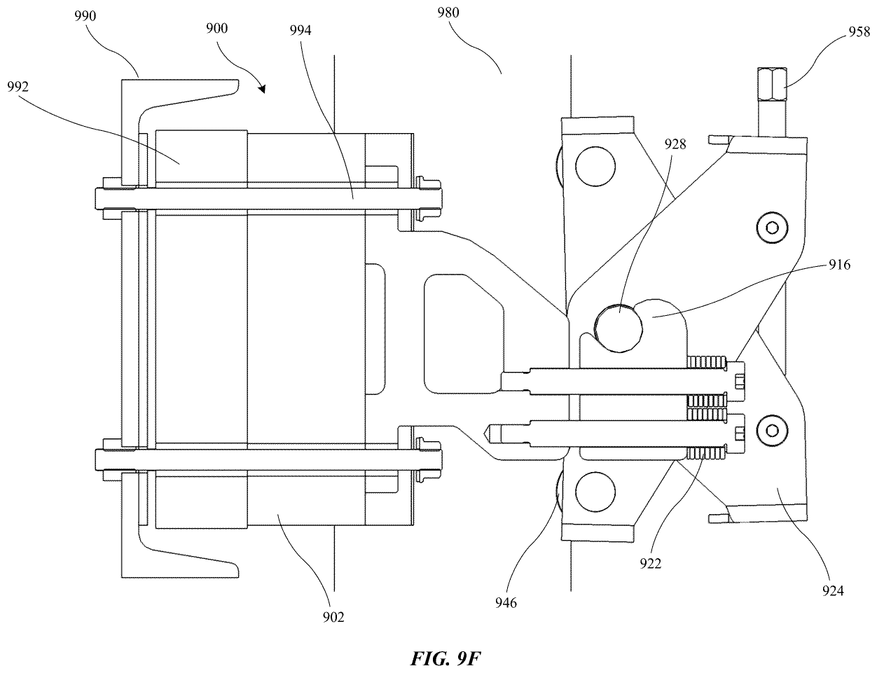

FIGS. 9A-9F illustrate one embodiment of an upper electrode clamp or stem clamp 900 that may be used in a metallurgical system. For example, stem clamp 900 may be used in metallurgical system 100, such as for stem clamp 170 and/or as another clamp that may be engaged with a stem of a stem assembly to support and/or axially translate the stem assembly and/or an electrode stack relative to a refractory vessel. Stem clamp 900 may include a fixed body 902 that may be fixedly mounted on a support structure, such as a bridge or support structure 165 shown in FIG. 1. For example, a rear surface of fixed body 902 (which may be planar or substantially planar in some embodiments) may be positioned against and secured to the support structure, such as by welding and/or using one or more fasteners. The fixed coupling between fixed body 902 and the support structure may enable movement of the support structure to cause a corresponding movement of stem clamp 900 and any stem assembly and/or electrode stack that is secured within stem clamp 900. Fixed body 902 may include an arcuate saddle 904 that is sized and shaped to receive a stem of a stem assembly. Arcuate saddle 904 may include a rear surface that is coupled to the support structure and an arcuate clamping surface 908 that may contact a stem of a stem assembly. For example, a radius of arcuate clamping surface 908 may be equal to or substantially match the radius of the stem. In some embodiments, the radius of arcuate clamping surface 908 may be greater than the radius of the stem by between or about 0.1% and 5%, between or about 0.25% and 2.5%, or between or about 0.5% and 1%, although other values are possible in various embodiments. For example, in some embodiments the radius of arcuate clamping surface 908 may be equal to the radius of the stem. Arcuate saddle 904 may have an open top and bottom end, which may enable a portion of the stem extend above and/or below arcuate saddle 904 when the stem is secured within stem clamp 900. The arc of arcuate clamping surface 908 and/or arcuate saddle 904 may extend along between about 60 degrees and 180 degrees to enable the stem to be inserted within and removed from the arcuate saddle 904 from a front side (e.g., toward arcuate clamping surface 908) of arcuate saddle 904. In some embodiments, arcuate clamping surface 908 may have a contact area sized to provide a current density per area of between about 0.5 A/cm² and 1.5 A/cm². While described as being arcuate, in some embodiments arcuate saddle 908 may include a number of facets that define a generally arcuate shape formed of a number of linear surfaces.

In some embodiments, an inner arcuate surface of arcuate saddle 904 may include one or more grooves 906 that may extend axially along a length of arcuate saddle 904. Grooves 906 may divide a gripping surface of arcuate saddle 904 into a number of segments, which may provide multiple benefits. For example, the use of multiple segments may help improve the uniformity of force applied to the stem, even when there are irregularities (e.g., high spots) in arcuate clamping surface 908 of arcuate saddle 904 and/or the stem. Additionally, the use of smaller segments may increase the pressure applied by stem clamp 900 to the stem and may better hold the stem in place. It will be appreciated that some embodiments may omit grooves 906 and the surface of arcuate saddle 904 may be smooth and/or may have another texture and/or groove pattern that divides the gripping surface into a number of smaller regions.

Arcuate saddle 904 and/or other components of stem clamp 900 may be formed from a conductive material, such as copper, aluminum, and/or other metal. Arcuate saddle 904 may be coupled with an electrical busbar and/or other current carrier that is provided on the support structure. The coupling of arcuate saddle 904 with the busbar may enable current to be passed through the busbar, stem clamp 900, a stem assembly, an electrode stack coupled to the stem assembly, and into the refractory vessel.

Fixed body 902 may include one or more arms 910 that extend outward from a front surface of arcuate saddle 904 and away from the support structure. For example, each arm 910 may be positioned laterally outward from arcuate clamping surface 908. As illustrated, a first arm 910a extends from a first side of arcuate saddle 904 and a second arm 910b extends from an opposite second side of arcuate saddle 904, with the two arms being laterally spaced apart from one another by arcuate clamping surface 908. Each arm 910 may be formed integrally with arcuate saddle 904 in some embodiments, while in other embodiments arms 910 may be separately formed and later joined with arcuate saddle 904, such as using one or more fasteners. As illustrated each arm 910 is secured to arcuate saddle 904 using a number of bolts 912 or other fasteners that extend through both components. For example, a proximal end of each arm 910 may include at least one flange 914 that provides a surface through which one or more bolts 912 may be inserted. While shown with two flanges 914 on each arm 910 with each flange 914 receiving a single bolt 912, it will be appreciated that other numbers of flanges 914 and/or bolts 912 may be used and that other coupling techniques may be used in various embodiments.

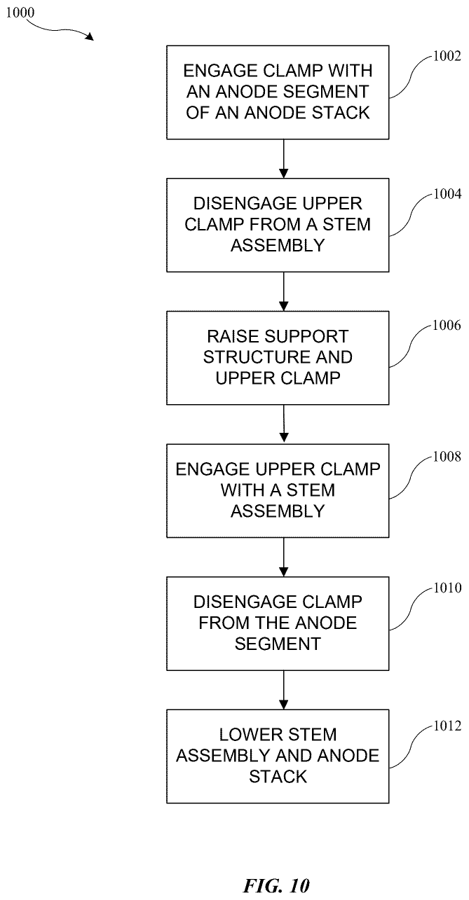

Each arm 910 may include a support arm hook 916 that may extend outward from a distal end of arm 910. For example, a block 918 or other body may be coupled to arm 910 and include a hook-like feature that forms support arm hook 916. An opening of an interior of support arm hook 916 may face the front surface of arcuate saddle 904. In some embodiments, each support arm hook 916 may be spring-biased toward the respective arm 910 along a longitudinal axis of the arm 910 (e.g., in a direction that is substantially orthogonal to the rear surface of arcuate saddle 904). For example, as best illustrated in FIG. 9F, shoulder bolts 920 are inserted through a distal surface of block 918, extend through a thickness of block 918, and into arm 910 to secure block 918 to arm 910. A compression spring 922 is disposed between a head of each shoulder bolt 920 and the distal surface of block 918. Spring force from compression springs 922 may spring-bias block 918 and support arm hook 916 toward arm 910. As will be discussed in greater detail below, by biasing support arm hook 916 toward arm 910 and arcuate saddle 904, stem clamp 900 may apply some level of clamping force to a stem of a stem assembly that helps maintain the stem in electrical contact with the arcuate clamping surface 908 even when stem clamp 900 is loosened/partially disengaged to permit relative movement between the stem and stem clamp 900. The continued electrical contact as stem clamp 900 is loosened enables metallurgical operations (such as MOE) to be continued during a regrip process, such as that described in relation to FIG. 10. In some embodiments, compression springs 922 may provide at least 500 lb of spring force, at least 750 lb of spring force, at least 1000 lb of spring force, at least 1250 lb of spring force, at least 1500 lb of spring force, or more when stem clamp 900 is loosened.

Stem clamp 900 may include a clamp body 924 that is removably coupled to fixed body 902. For example, clamp body 924 may be removed from fixed body 902 to enable a stem to be inserted or removed from stem clamp 900. Clamp body 924 may be engaged with fixed body 902 to secure a stem within stem clamp 900. As best illustrated in FIGS. 9B and 9C, clamp body 924 may include a number of body members 926 that are movably coupled with one another. For example, a first body member 926a may be pivotally or otherwise rotatably coupled to a second body member 926b. Body members 926 may be coupled together via an axle 928 that pivotally couples the two body members 926 together and enables body members to rotate relative to one another about axle 928. In some embodiments, axle 928 extends laterally beyond each body member 926. The protruding portion of axle 928 may be inserted into support arm hooks 916 to couple clamp body 924 with fixed body 902.

Each body member 926 may include two lateral side members 930 that are parallel to one another. Lateral side members 930 may be coupled with one another by one or more end members 932. For example, as illustrated a single end member 932 may couple two lateral side members 930 together such that each body member 926 is generally U-shaped. It will be appreciated that other designs are possible. In some embodiments, end member 932 may define an aperture or cutout 940 that may provide clearance for a tightening mechanism of stem clamp 900 as will be discussed in greater detail below. Each lateral side member 930 of body member 926 may include a first end 934 and a second end 936, with a medial region 938 extending between and coupling first end 934 and second end 936. First ends 934 may be coupled together via end member 932, while second ends 936 may be spaced apart and remain unfixed with one another. In some embodiments, medial region 938 may be angled such that first end 934 and second end 936 are laterally offset from one another. The use of such an offset between first ends 934 and second ends 936 may increase a pivot range of two body members 926 when body members 926 are pivotally coupled together.

In some embodiments, first body member 926a and second body member 926b may have different widths. Such sizing may enable one of first body member 926a and second body member 926b to be received within an interior of the other body member 926. In other embodiments, first body member 926a and second body member 926b may have a same width. In such embodiments, lateral side members 930 of two body members 926 may be interleaved with one another when the two body members 926 are coupled about axle 928. For example, one lateral side member 930 of first body member 926a may be disposed outside of the lateral side members 930 of second body member 926b, while the other lateral side member 930 of first body member 926a may be disposed between the lateral side members 930 of second body member 926b. The use of first body member 926a and second body member 926b having a same width may enable a single body member design to be utilized for both first body member 926a and second body member 926b. For example, first body member 926a and second body member 926b may have a same structural size and shape, with the two body members 926 being inverted relative to one another such that first end 934 of one body member 926 is on a same side (e.g., within a 180 degree region) of axle 928 as second end 936 of the other body member 926. In such embodiments, the angle of medial regions 938 may result in the coupling between the two body members 926 being generally X-shaped when viewed along a longitudinal axis of axle 928. Opposing first ends 934 of body members 926 and/or cutouts 940 may be aligned along a first vertical axis 942 while opposite second ends 936 of body members 926 may be aligned along a second vertical axis 944 that is parallel to the first vertical axis 942. Axle 928 may be positioned between first vertical axis 942 and second vertical axis 944.

Clamp body 924 may include one or more clamping surfaces 946 that are each positioned opposite arcuate saddle 904 when axle 928 is inserted within support arm hooks 916. Clamping surfaces 924 may be positioned relative to arcuate saddle 904 to apply a compressive force to a stem positioned within stem clamp 900, with the compressive force being sufficient to prevent the stem (and stem assembly and electrode stack) from moving axially relative to stem clamp 900. For example, in some embodiments, clamping surfaces 946 and accurate saddle 904 may apply a clamping force of between or about 8500 N and 270000 N. Each clamping surface 946 may be coupled to one or both body members 926. In a particular embodiment, each clamping surface 946 may extend between and be coupled with inner surfaces of second end 936 of a single one of body members 926. For example, clamping surface 946 may be disposed within an interior of one body member 926, such as between lateral side members 930. In a particular embodiment, each clamping surface 946 may be in the form of a roller 948 that may rotate about a central axle 950. Clamp body 924 may include one or more rollers 948. For example, clamp body 924 may include at least one roller, at least two rollers, at least three rollers, at least four rollers, or more. When multiple rollers 948 are use, rollers 948 may be spaced at regular or irregular intervals. For example, in the illustrated embodiment rollers 948 are positioned on opposite sides of axle 928 with each roller being equidistant from axle 928. One roller 948 may be positioned on an upper portion (e.g., above axle 928) of first body member 926a, while a second roller 948 may be positioned on a lower portion (e.g., below axle 928) of second body member 926b, although other configurations are possible.

Each central axle 950 may be parallel to axle 928 and may be positioned on an inner side of clamp body 924 such that rollers 948 face arcuate clamping surface 908 when clamp body 924 is engaged with fixed body 902. In some embodiments, each central axle 950 may be coupled to second ends 936 of one of the two body members 926 such that rollers 948 are spaced apart along at least a portion of the length of clamp body 924. Each central axle 950 may extend through openings formed within lateral side members 930, with each roller 948 being rotatably mounted on central axle 950 and disposed within an interior of body members 926. In a particular embodiment, each lateral side member 930 may be bent to form a U-channel 952 at second end 936. Roller 948 may be disposed between inner surfaces of U-channel 952. In some embodiments, a bushing 954 or other spacer may be disposed within U-channel 952.

In some embodiments, each roller 948 may include a concave and arcuate roller surface to increase a contact area between rollers 948 and the cylindrical stem. In some embodiments, a radius of the arcuate roller surface be equal to or substantially match a radius of the stem. For example, a radius of roller 948 may substantially match the radius of the stem. In some embodiments, the radius of roller 948 may be greater than the radius of the stem by between or about 0.1% and 5%, between or about 0.25% and 2.5%, or between or about 0.5% and 1%, although other values are possible in various embodiments.

In some embodiments, each clamping surface 946 may have a hardness that is within about 10% of that of the stem, within 5%, within 3%, within 1%, or less. By substantially matching the hardness of clamping surface 946 and the stem, deformation of one or both components may be reduced or prevented when clamping force is applied to the stem by clamping surface 946 of stem clamp 900. In some embodiments, clamping surfaces 946 may be formed from a same material as stem, such as aluminum. In other embodiments, clamping surfaces 946 may be made from other metals, ceramics, and/or other hard materials, which may or may not be electrically conductive. While discussed with clamping surfaces 946 being in the form of rollers 948, other clamping surfaces, such as smooth and/or low friction surfaces, that may facilitate axial movement of the stem as the stem clamp 900 is loosened may be utilized in other embodiments.

Clamp body 924 may include one or more adjustment mechanisms that may enable a clamping force of stem clamp 900 to be adjusted, such as by moving clamping surfaces 946 closer to or further from arcuate saddle 904 when axle 928 is secured within support arm hooks 916. In some embodiments, the adjustment mechanism may be configured to pivot the two body members 926 relative to one another about axle 928. When tightening stem clamp 900, the pivoting of body members 926 may cause first ends 934 to move closer together along a vertical axis (e.g., an axis extending through both clamping surfaces 946), second ends 936 to move closer together along a vertical axis, and first ends 934 to move away from second ends 936 along a horizontal axis (e.g., an axis extending through both axle 928 and arcuate clamping surface 908). When clamp body 924 is engaged with fixed body 902 (e.g., with axle 928 secured within support arm hooks 916), the movement of first ends 934 away from second ends 936 along the horizontal axis causes clamping surfaces 946 to move toward arcuate saddle 904 to increase an amount of clamping force applied by stem clamp 900. When loosening stem clamp 900, the pivoting of body members 926 may cause first ends 934 to move further apart along a vertical axis, second ends 936 to move further apart along a vertical axis, and first ends 934 to move closer to second ends 936 along a horizontal axis. When clamp body 902 is engaged with fixed body 902 (e.g., with axle 928 secured within support arm hooks 916), the movement of first ends 934 closer to second ends 936 along the horizontal axis causes clamping surfaces 946 to move away from arcuate saddle 904 to decrease an amount of clamping force applied by stem clamp 900.

In some embodiments, the adjustment mechanism of stem clamp 900 may include a number of nut blocks 956 that are coupled to the body members 926. For example, a first nut block 956a may be coupled to a lower portion of first body member 926a and a second nut block 956b may be coupled to an upper portion of second body member 926b. As illustrated, each nut block 956 may extend between and be coupled to lateral side members 930 of one of the body member 926. For example, first nut block 956a may be coupled with lateral side members 930 of first body member 926a and second nut block 956b may be coupled with lateral side members 930 of second body member 926b. In some embodiments each nut block 956 extends between and couples inner surfaces of the lateral side members 930 of the respective body member 926. In some embodiments, nut blocks 956 may be secured to body members 926 via one or more fasteners, such as screws that extend through nut block 956 and through at least one lateral side member 930. By coupling first nut block 956a to a lower portion of first body member 926a and a second nut block 956b to an upper portion of second body member 926b, relative movement between nut blocks 956 may cause a corresponding change in relative positions of first ends 934 and second ends 936 to adjust the clamping force applied by stem clamp 900 as discussed above.

The adjustment mechanism may include a tightening mechanism that adjusts a distance between nut blocks 956 to cause a corresponding adjustment to the distance between clamping surfaces 946 and arcuate saddle 904 as described above. For example, each nut block 956 may define a threaded aperture, with the threaded apertures of first nut block 956a and second nut block 956b being aligned along a vertical axis. The tightening mechanism may be a bolt 958 or other threaded member that may be inserted within and engaged with the threaded apertures of each nut block 956. Threads of the threaded aperture of first nut block 956a may be oriented in an opposite direction as threads of the threaded aperture of second nut block 956b, which may enable rotation of the bolt to move nut blocks 956 in opposite directions. Thus, when the bolt is rotated in a first direction, nut blocks 956 move toward one another, which causes first ends 934 to move closer together along a vertical axis, second ends 936 to move closer together along a vertical axis, and first ends 934 to move away from second ends 936 along a horizontal axis. When clamp body 924 is engaged with fixed body 902 (e.g., with axle 928 secured within support arm hooks 916), the lateral movement of first ends 934 away from second ends 936 along the horizontal axis causes clamping surfaces 946 to move toward arcuate saddle 904 to increase an amount of clamping force applied by stem clamp 900. When the bolt is rotated in a second opposite direction, nut blocks 956 move away from one another, which causes first ends 934 to move away from one another together along a vertical axis, second ends 936 to move away from one another along a vertical axis, and first ends 934 to move closer to second ends 936 along a horizontal axis. When clamp body 924 is engaged with fixed body 902 (e.g., with axle 928 secured within support arm hooks 916), the lateral movement of first ends 934 closer to second ends 936 along the horizontal axis causes clamping surfaces 946 to move away from arcuate saddle 904 to decrease an amount of clamping force applied by stem clamp 900.

In some embodiments, the bolt 958 may be positioned at a top end of clamp body 924. For example, a head of bolt 958 (which may be grasped by a tool, such as a socket, wrench, and/or other tool to rotate bolt 958) may extend above a top end of each body member 926, while the threaded portion of bolt 958 extends downward through at least a portion of length of each body member 926, such as extending through cutouts 940. Such positioning of the head of bolt 958 may enable the tool to be readily interfaced with the head of bolt 958 without interference from other components of the metallurgical system. In other embodiments, bolt 958 may be positioned at other locations of clamp body 924. For example, a head of bolt 958 may be positioned at a bottom end of clamp body 958, which may provide a lower access point for users to adjust the tightness of clamp 900. Lateral positions of bolt 958 may be utilized in some embodiments.

FIGS. 9D-9F illustrate a stem 980 of a stem assembly secured within stem clamp 900. Stem assembly may be similar to stem assemblies 173 and 800 and may include any of the features described in relation to stem assemblies 173 and 800. The stem assembly may be coupled to an electrode stack, such as electrode stacks 140, 540, 740, and 830. As shown in FIG. 9F, stem clamp 900 may be mounted on a bridge or other support structure 990 (which may be similar to support structure 165), which may extend above a metallurgical vessel. In some embodiments, support structure 990 may include one or more I-beams and/or other structural elements that may support various components of a metallurgical system. Support structure 990 may include and/or otherwise be coupled to a busbar 992. Busbar 992 may be supported by support structure 990 and may be electrically coupled to a power source (not shown) to deliver power to metallurgical system. For example, current may be passed through a circuit formed by busbar 992, stem clamp 900 (e.g., arcuate saddle 904), stem 980, an electrode coupler, and an electrode stack. Fixed body 902 may be electrically coupled to busbar 992. For example, a portion of fixed body 902 (such as a portion laterally outward from arcuate saddle 904 on one or both sides of arcuate saddle 904) may define one or more apertures that may receive fasteners 994, such as bolts, which may be used to mount fixed body 902 to support structure 990. Fasteners 994 may be formed from conductive materials and may extend through a portion of support structure 990 and into and/or otherwise contacting busbar 992 to electrically couple fixed body 902 with busbar 992. It will be appreciated that other techniques may be used to electrically couple fixed body 902 with busbar 992 in various embodiments. In operation, current may be passed through busbar 992, stem clamp 900, a stem assembly (which may include stem 980, as well as connectors that couple stem 980 with stem clamp 900 and an electrode stack), and the electrode stack.

Stem 980 may be inserted within stem clamp 900 in a loosened position, with a small gap (e.g., less than or equal to 1 inch, less than or equal to 0.75 inch, less than or equal to 0.5 inch, less than or equal to 0.25 inch) being provided between stem 980 and one or both of arcuate clamping surface 908 and at least one clamping surface 946. Stem clamp 900 may be in a partially tightened configuration, with a portion of stem 980 being positioned against the arcuate clamping surface 908 and another portion of stem 980 being positioned against clamping surfaces 946. In the loosened position, spring force from springs 922 may force support arm hooks 916 (and clamp body 924 via the engagement between axle 928 and support arm hooks 916) toward arcuate saddle 904 and stem 980 to maintain clamping surfaces 946 and/or arcuate clamping surface 908 in contact with stem 980. For example, in some embodiments support arm hooks 916 collectively apply at least 100 lb of spring force (e.g., springs 922 may collectively have a spring force of at least 100 lb) to clamp body 924 when axle 928 is received within the support arm hooks 916 and clamp body 924 is partially tightened to force clamping surfaces 946 against stem 980 (i.e., when stem clamp 900 is in the partially tightened configuration). The contact between clamping surfaces 946 and stem 980 may enable stem 980 to remain electrically coupled with fixed body 902 (e.g., via contact with arcuate saddle 904) and busbar 992 both when stem clamp 900 is in a tightened configuration and the partially tightened configuration. In the partially tightened configuration, stem clamp 900 may permit stem 980 to move axially (such as by enabling rollers 948 to rotate about central axes 950), which may enable a regrip process to be performed as described in relation to FIG. 10. Bolt 958 may be rotated to increase a clamping force and to tighten stem clamp 900, such as by causing nut blocks 956 to move toward one another to force clamping surfaces 946 toward arcuate saddle 904. In the tightened configuration, stem clamp 900 may apply sufficient force to the stem assembly to lock the stem assembly in position in an axial direction. For example, force applied to stem 980 may be sufficient to overcome gravitational forces on the stem assembly and electrode stack.

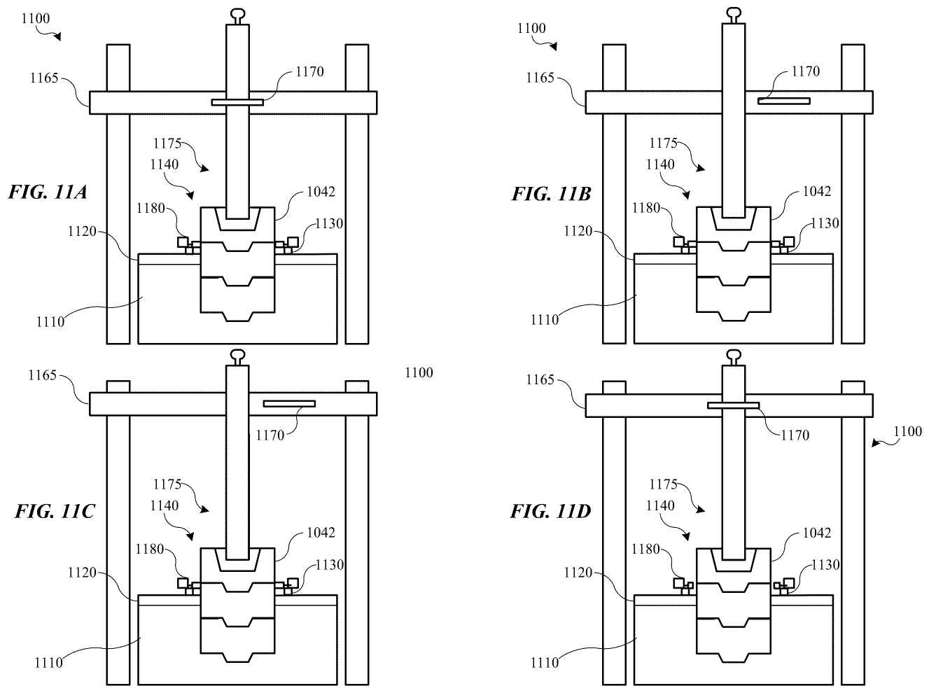

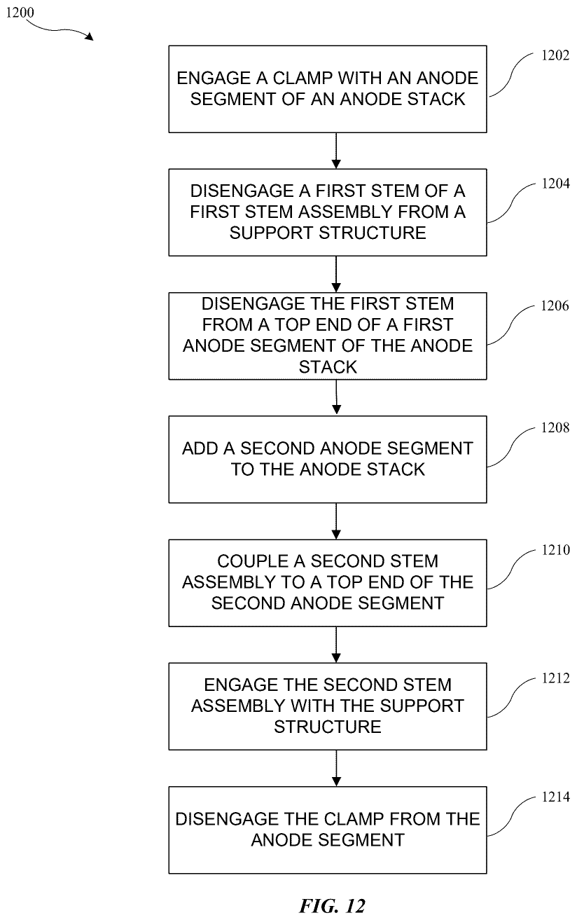

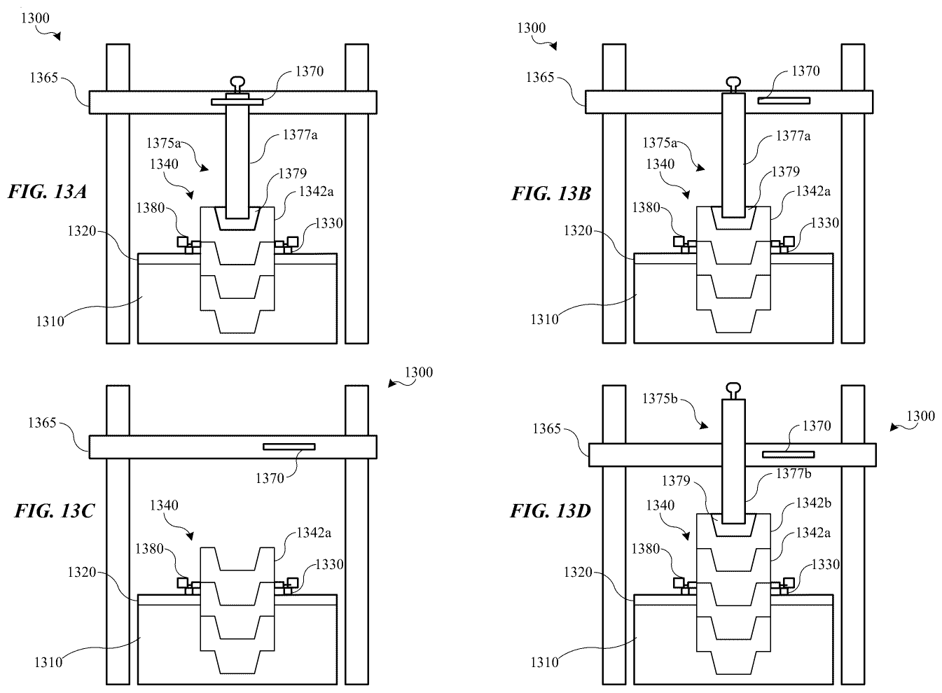

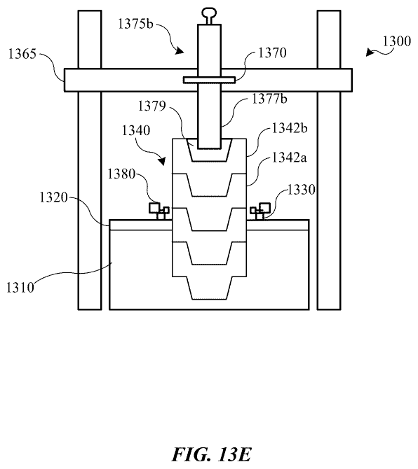

As noted above, metallurgical systems and components thereof described herein may enable regripping procedures that may enable greater axial travel of electrodes and continuous feed of electrodes (such as by adding additional electrode segments to an electrode stack). FIG. 10 is a flowchart illustrating a regrip process 1000 that enables the greater axial travel of electrode stacks, as well as may enable the continuous feed of electrode stacks (as will be discussed in greater detail in relation to FIGS. 12-13E). Regrip process 1000 is discussed in conjunction with FIGS. 11A-11D, which illustrate movement of portions of a metallurgical system 1100 during regrip process 1000, however regrip process 1000 may be performed using any of the metallurgical systems described herein, including metallurgical systems 100, 200, 500, and 700. Metallurgical system 1100 may be similar to metallurgical systems 100, 200, 500, and 700 and may include any of the features described in relation to these metallurgical systems. Process 1000 may be performed, for example, when a support structure 1165 of metallurgical system 1100 has reached a lower travel limit. For example, during operation of metallurgical system 1100, support structure 1165 may be gradually lowered (e.g., continuously and/or intermittently) as an electrode stack 1140 is gradually consumed in a reaction that generates heat for metallurgical operations, such as, but not limited to, molten oxide electrolysis (MOE) processes to produce liquid iron, ferroalloys, and/or other materials. Oftentimes, support structure 1165 may have a vertical travel range that is less than a length of electrode stack 1140 and/or there may be a need to create additional room for insertion of an additional electrode segment to an electrode stack to facilitate continuous feeding of electrodes into a refractory vessel 1110 of metallurgical system 1100. Regrip process 1000 provides solutions to such vertical travel limit of support structure 1165. Support structure 1165 may be coupled to and may support a stem assembly 1175 (which may include any of the features described in relation to stem assemblies 173 and 800) and electrode stack 1140 (which may include one or more electrode segments 1142 as described herein), such as via a stem clamp 1170 (such as stem clamps 170 and 900). Regrip process 1000 may be performed with at least a portion of a stem of stem assembly 1175 extends upward beyond stem clamp 1170.

Regrip process 1000 may begin at operation 1002 by engaging a clamp with an electrode segment of electrode stack 1140, with the clamp inhibiting movement of the electrode stack 1140 as illustrated in FIG. 11A. For example, a electrode clamp 1180 (which may be similar to and include any features described in relation to electrode clamps 180 and 600) may be used to clamp electrode stack 1140. As just one example, electrode clamp 1180 may include a clamping surface (e.g., clamping surface 616) that clamps against a peripheral surface of one of electrode segments 1142 of electrode stack 1140. Electrode clamp 1180 may be seated atop an additional support structure of metallurgical system 1100, such as a lid 1120, an I-beam positioned above lid 1120, and/or other support structure. The normal force between electrode clamp 1180 and the additional support structure of metallurgical system 1100 may inhibit axial movement of electrode stack 1140 relative to refractory vessel 1110. In other embodiments, a clamp or other gripping mechanism coupled with a crane may be used to clamp electrode stack 1140 to inhibit axial movement of electrode stack 1140. In some embodiments, each electrode segment 1142 of electrode stack 1140 may include a slit or other channel formed in a peripheral surface of the electrode segment. A support material, such as a sheet, plate, rod, or other piece of metal or other rigid material that can withstand the temperature proximate lid 1120 (which may exceed 600° C.) and a weight of electrode stack 1140 and stem assembly 1175 without yielding, may be inserted within the slit or channel of the electrode segment. A portion of the support material may sit atop lid 1120 or other structure above refractory vessel 1110. Normal forces between lid 1120 (or other structure), the support material, and portion of the electrode segment defining the slit or channel may inhibit axial movement of electrode stack 1140 relative to refractory vessel 1110.

Once the clamp (such as electrode clamp 1180) has been engaged with electrode stack 1140, stem clamp 1170 may be at least partially disengaged from stem assembly 1175 at operation 1104 as illustrated in FIG. 11B. For example, stem clamp 1170 may be loosened to a degree that permits relative movement between stem assembly 1175 and stem clamp 1170. In some embodiments, one or more rollers (which may be similar to rollers 948) of stem clamp 1170 may remain forced against a surface of the stem of stem assembly 1175 to enable a current to flow between a busbar (e.g., busbar 992) coupled to support structure 1165, stem clamp 1170, stem assembly 1175, and electrode stack 1140 while stem clamp 1170 permits relative movement of stem assembly 1175. As electrode clamp 1180 (or other clamp) is engaged with electrode stack 1140, electrode stack 1140 will not move axially (e.g., downward) even as stem clamp 1170 is loosened/disengaged.

At operation 1006, at least a portion of support structure 1165 and stem clamp 1170 may be raised as shown in FIG. 11C. For example, one or more linear actuators coupled with support structure 1165 may be operated to raise support structure 1154 along a generally vertical axis. As support structure 1165 is raised, stem assembly 1175 and electrode stack 1140 remain stationary, supported by electrode clamp 1180 (or other clamp engaged with a portion of stem assembly 1175 and/or electrode stack 1140). Support structure 1165 may be raised such that stem clamp 1180 is positioned about a higher portion of the stem of stem assembly 1175.

Once support structure 1165 and stem clamp 1170 are raised to a desired position, stem clamp 1170 may be tightened and/or engaged with the stem of stem assembly 1175 at operation 1008 and as illustrated in FIG. 11D. For example, a clamping surface of stem clamp 1170 may be tightened against a higher portion of the stem of stem assembly 1175 than previously done. At operation 1010, electrode clamp 1180 (or other clamp engaged at operation 1004) may be disengaged from the electrode stack 1140. The disengagement of electrode clamp 1180 may permit movement of electrode stack 1140 relative to refractory vessel 1110. For example, the higher clamp position and higher position of support structure 1165 (e.g., above a lower travel limit of support structure 1165) may enable support structure 1165 to further lower stem assembly 1175 and electrode stack 1140 relative to refractory vessel 1110 at operation 1012. Electrode stack 1140 may slide through an opening formed in an electrode seal 1130 (which may be similar to gas seal 130 and/or electrode seal 300) as electrode stack 1140 is lowered into refractory vessel 1110.

As noted above, the ability to regrip the stem assembly at a higher position may also enable a continuous electrode feed process in which additional electrode segments are added to an electrode stack without stopping operation of the metallurgical system. FIG. 12 is a flowchart illustrating a process 1200 for adding additional electrode segments to an electrode stack, which may enable the continuous feed of electrodes. Process 1200 is discussed in conjunction with FIGS. 13A-13E, which illustrate movement of portions of a metallurgical system 1400 during process 1200, however process 1200 may be performed using any of the metallurgical systems described herein, including metallurgical systems 100, 200, 500, 700, and 1100. Metallurgical system 1300 may be similar to metallurgical systems 100, 200, 500, 700, and 1100 and may include any of the features described in relation to these metallurgical systems. Process 1200 may be performed, for example, as electrode segments of an electrode stack 1340 of metallurgical system 1300 are consumed to ensure that a length of electrode stack 1340 is sufficiently large that downward movement of support structure 1365 maintain a lower portion of electrode stack 1340 in contact with an electrolyte provided within a refractory vessel 1310 of metallurgical system 1300. For example, during operation of metallurgical system 1300, support structure 1365 may be gradually lowered (e.g., continuously and/or intermittently) as electrode stack 1340 is gradually consumed during metallurgical operations, such as, but not limited to, molten oxide electrolysis (MOE) processes to produce liquid iron, ferroalloys, and/or other materials. Rather than replacing electrode stack 1340 as electrode stack 1340 is consumed by this reaction, additional electrode segments may be added to a top end of electrode stack 1340 and during operation of metallurgical system 1300 such that electrode stack 1340 is always sufficiently long to remain in contact with the electrolyte while a portion of electrode stack 1340 remains above a lid 1320 of refractory vessel 1310. The addition of electrode segments to electrode stack 1340 may enable metallurgical system 1300 to stay at operating temperatures, rather than being disrupted or shut down while a consumed electrode stack is removed and replaced. The removal and replacement of an electrode stack may cause excess heat loss within the metallurgical system and may require additional time and energy expenditure to get metallurgical system back into an operational state. Thus, process 1200 for adding additional electrode segments to an electrode stack and feeding (e.g., at a slow, continuous rate, intermittently, at intervals, etc.) electrode stack 1340 into refractory vessel 1310 without suspending operation of metallurgical system 1300 may ensure stability of the metallurgical processes.

Process 1200 may begin at operation 1202 by engaging a clamp with a first electrode segment 1342a of electrode stack 1340 as illustrated in FIG. 13A. The clamp may inhibit the first electrode segment 1342a from moving in an axial direction (i.e., along a longitudinal axis of first electrode segment 1342a). For example, a electrode clamp 1380 (which may be similar to and include any features described in relation to electrode clamps 180, 600, and 1180) may be used to clamp electrode stack 1340. As just one example, electrode clamp 1380 may include a clamping surface that clamps against a peripheral surface of one or more of the electrode segments (which may be electrode segment 1342a and/or another electrode segment that is positioned below first electrode segment 1342a) of electrode stack 1340. Electrode clamp 1380 may be seated atop an additional support structure of metallurgical system 1300, such as a lid 1320, I-beam positioned above lid 1320 (e.g., I-beam 517, 717, etc.), and/or other additional support structure. The normal force between electrode clamp 1380 and the additional support structure of metallurgical system 1300 may inhibit axial movement of electrode stack 1340 relative to refractory vessel 1310. In other embodiments, a clamp or other gripping mechanism coupled with a crane may be used to clamp electrode stack 1340 to inhibit axial movement of electrode stack 1340. In some embodiments, each electrode segment 1342 of electrode stack 1340 may include a slit or other channel formed in a peripheral surface of the electrode segment 1342. A support material, such as a sheet, plate, rod, or other piece of metal or other rigid material that can withstand the temperature proximate lid 1320 (which may exceed 600° C.) and a weight of electrode stack 1340 and stem assembly 1375 without yielding, may be inserted within the slit or channel of the electrode segment. A portion of the support material may sit atop lid 1320 or other structure above refractory vessel 1310. Normal forces between lid 1320 (or other structure), the support material, and portion of the electrode segment defining the slit or channel may inhibit axial movement of electrode stack 1340.

At operation 1204, a first stem 1377a of a first stem assembly 1375a may be disengaged from support structure 1365 as illustrated in FIG. 13B. For example, once the clamp (such as electrode clamp 1380) has been engaged with electrode stack 1340, a stem clamp 1370 (which may be similar to stem clamps 170 and 900) may be disengaged from stem assembly 1375. For example, stem clamp 1370 may be loosened to a degree that permits a clamp body (which may be similar to and include any features of clamp body 924) of stem clamp 1370 to be removed from a saddle (e.g., arcuate saddle 904) of stem clamp 1370, which may enable stem 1377 to be removed from stem clamp 1370. As electrode clamp 1380 (or other clamp) is engaged with electrode stack 1340, electrode stack 1340 and stem assembly 1375 will not move axially (e.g., downward) even as stem clamp 1370 is disengaged.

At operation 1206, first stem 1377 may be disengaged from a top end of first electrode segment of electrode stack 1340, which may occur after first stem 1377 is disengaged from support structure 1365 in some embodiments. First electrode segment is the uppermost electrode segment in electrode stack 1340 and may or may not be the electrode segment that is clamped. To disengage first shaft 1377 from the first electrode segment of electrode stack 1340, a second connector (which may be similar to and include any of the features described in relation to second connector 820) of an electrode coupler 1379 of stem assembly 1375 may be decoupled from a first connector of first electrode segment 1342a of electrode stack 1340. In some embodiments, the decoupling may involve rotating electrode coupler 1379 of stem assembly 1375 relative to electrode stack 1340 to disengage threads of the second connector of electrode coupler 1379 from threads of the first connector of the first electrode segment 1342a of electrode stack 1340. For example, one or more tools, such as wrenches, may be interfaced with wrenching flats and/or other non-circular features of electrode coupler 1379 to apply a torque to electrode coupler 1379 while electrode stack 1340 remains clamped to rotate the components relative to one another to disengage the corresponding threads. Once first stem assembly 1375a is disengaged from the top end of first electrode segment 1342a, first stem assembly 1375a may be removed from metallurgical system 1300, such as by using a crane or other robotic tool as illustrated in FIG. 13C. For example, a grasping mechanisms (such as a hook) of the crane may be inserted into and/or otherwise interface with an eyelet portion of first stem assembly 1375a to enable the crane to carry first stem assembly 1375a away from stem clamp 1370 and electrode stack 1340. Electrode stack 1340 may remain positioned partially within refractory vessel 1310 due to the engagement of electrode clamp 1380 (or other clamp) with at least one of the electrode segments 1342 of electrode stack 1340.

Upon removal of first stem assembly 1375a, the first connector of first electrode segment 1342a may be exposed, which may enable a second electrode segment 1342b to be added to electrode stack 1340 at operation 1208 as illustrated in FIG. 13D. For example, second electrode segment 1342b may be coupled to first electrode segment 1342a, such as by coupling the second connector of second electrode segment 1342b to the exposed first connector of first electrode segment 1342a. In some embodiments, the coupling of the second connector of second electrode segment 1342b to the exposed first connector of first electrode segment 1342a may involve rotating second electrode segment 1342b relative to first electrode segment 1342a of electrode stack 1340 (which may remain at a fixed angular position due to electrode stack 1340 being clamped) to engage threads of the second connector of second electrode segment 1342b with threads of the first connector of first electrode segment 1342a of electrode stack 1340.

At operation 1210 a second stem assembly 1375b (which may be a new stem assembly or may involve re-using first stem assembly 1375a) may be coupled to a top end of second electrode segment 1342b. For example, one or more tools, such as wrenches, may be interfaced with wrenching flats and/or other non-circular features of electrode coupler 1379 of second stem assembly 1375b to apply a torque to electrode coupler 1379 to rotate second stem assembly 1375b relative to second electrode segment 1342b to engage the corresponding threads of the second connector of electrode coupler 1379 and the first connector of second electrode segment 1342b. In some embodiments, second stem assembly 1375b may be coupled to the top end of second electrode segment 1342b prior to coupling second electrode segment 1342b to electrode stack 1340. By coupling second stem assembly 1375b to second electrode segment 1342b prior to coupling second electrode segment 1342b to electrode stack 1340, second stem assembly 1375b may be used to transport second electrode segment 1342b into position above first electrode segment 1342a. For example, a grasping mechanism of a crane or other tool may be inserted into and/or otherwise interface with an eyelet portion of second stem assembly 1375b to enable the crane to carry second stem assembly 1375b into alignment and/or engagement with stem clamp 1370 and/or electrode stack 1340. In some embodiments, the crane may also be used to rotate second electrode segment 1342b relative to first electrode segment 1342a of electrode stack 1340 (which may remain at a fixed angular position due to electrode stack 1340 being clamped) to engage threads of the second connector of second electrode segment 1342b with threads of the first connector of first electrode segment 1342a of electrode stack 1340.

At operation 1212, second stem assembly 1375b may be engaged with support structure 1365. For example, stem clamp 1370 may be tightened and/or engaged with stem 1377b of second stem assembly 1375b as illustrated in FIG. 13E. For example, a clamping surface of stem clamp 1370 may be tightened against a portion of stem 1377 of second stem assembly 1375b to secure second stem assembly 1375b with support structure 1365, which may enable vertical movement of support structure 1365 to cause axial movement of second stem assembly 1375b and electrode stack 1340. At operation 1314, electrode clamp 1380 (or other clamp engaged at operation 1204) may be disengaged from the electrode stack 1340. The disengagement of electrode clamp 1380 may permit axial movement of electrode stack 1340 relative to refractory vessel 1310. For example, support structure 1365 may be lowered (continuously, intermittently, etc.) to lower second stem assembly 1375 and electrode stack 1340 relative to refractory vessel 1310. Electrode stack 1340 may slide through an opening formed in an electrode seal 1330 (which may be similar to gas seal 130 and/or electrode seal 300) as electrode stack 1340 is lowered into refractory vessel 1310.

In some embodiments, process 1200 may include raising at least a portion of support structure 1365 after disengaging the first stem 1377. For example, support structure 1365 may be raised prior to engaging the second stem 1377 within stem clamp 1370 to secure second stem 1377 to support structure 1365, which may enable second stem 1377 to be gripped at a lower position than the first stem 1377 was gripped by stem clamp 1370 prior to being disengaged from stem clamp 1370. By raising support structure 1365 and gripping second stem 1377 at the lower position, process 1200 may enable a larger range of vertical travel of electrode stack 1340 prior to performing a regrip process, such as process 1000. While discussed primarily for adding a single electrode segment to an electrode stack, it will be appreciated that any number of electrode segments may be added to a given electrode stack at a time.

Oftentimes, a metallurgical system may include a number of electrode stacks within a single refractory vessel. In such embodiments, it may be desirable to add new electrode segments to at least some of the electrode stacks at different times. By staggering the addition of electrode segments for different electrode stacks, embodiments may enable one or more of the electrode stacks to remain passing current (such as via a busbar coupled to the stem clamps holding each stem assembly and electrode stack) while some of the electrode stacks are having additional electrode segments added. Not only does staggering of the electrode stacks enable a metallurgical system to remain continuously operational for an indefinite period of time, but also may reduce the amount of equipment required to operate metallurgical system. For example, the number of cranes or other tools that are used to carry electrode segments and/or stem assemblies into and out of metallurgical system may be reduced. In some embodiments, only a single crane may be needed to handle transport of all electrode segments and/or stem assemblies without interrupting the operation of metallurgical system. The use of a small number of cranes may not only reduce the operating cost and/or complexity of metallurgical system, but may also provide benefits where spacing between electrode stacks is small, as there may be limited space for a large number of cranes to operate.

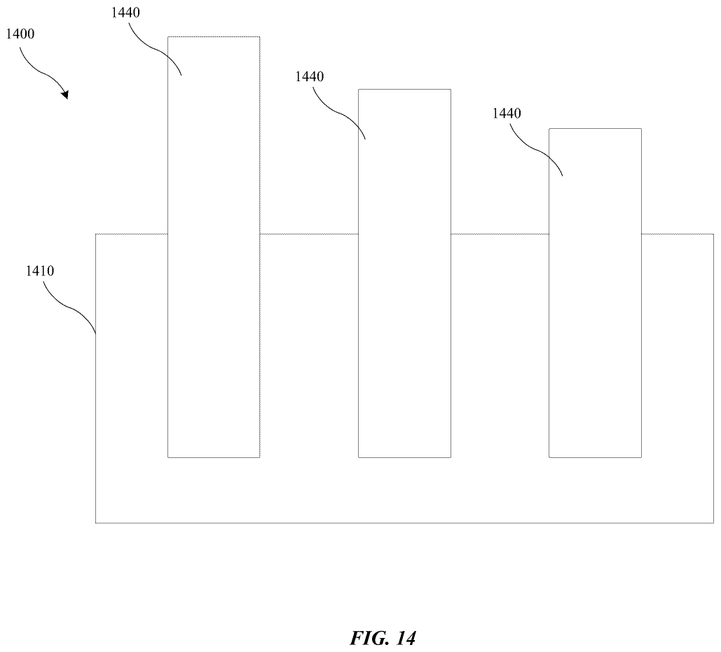

To achieve the staggering of adding electrode stacks, metallurgical system may be initialized with at least some of the electrode stacks having different lengths. FIG. 14 illustrates a metallurgical system 1400, which may be similar to and include any of the features described in relation to metallurgical systems 100, 200, 500, 700, 1100, and 1300. For example, metallurgical system 1400 may include a refractory vessel 1410 that receives a number of electrode stacks 1440. Some of all of the electrode stacks 1440 may have different lengths. For example, each electrode stack 1440 may include a different number of electrode segments and/or may include one or more electrode segments of a different length (e.g., a bottommost electrode segment may be trimmed and/or otherwise reduced in length and/or one of the electrode segments may be manufactured to be a different length). Bottom ends of each electrode stack 1440 may be positioned within refractory vessel 1410 at approximately (e.g., within 10%, within 5%, within 3%, within 1%, or less) a same distance from a bottom of refractory vessel 1410. By making at least some of the electrode stacks 1440 different lengths while keeping the bottom ends at a substantially similar vertical position, top ends of some or all of the electrode stacks 1440 may be at different heights relative to refractory vessel 1410. This may ensure that if each electrode stack 1440 is consumed at a substantially similar rate (e.g., within about 10% of one another) electrode stacks 1440 will be consumed and need to be added to at different times. In some embodiments, each electrode stack 1440 may have a different starting length, while in other embodiments only a portion of the electrode stacks 1440 may have different starting lengths.

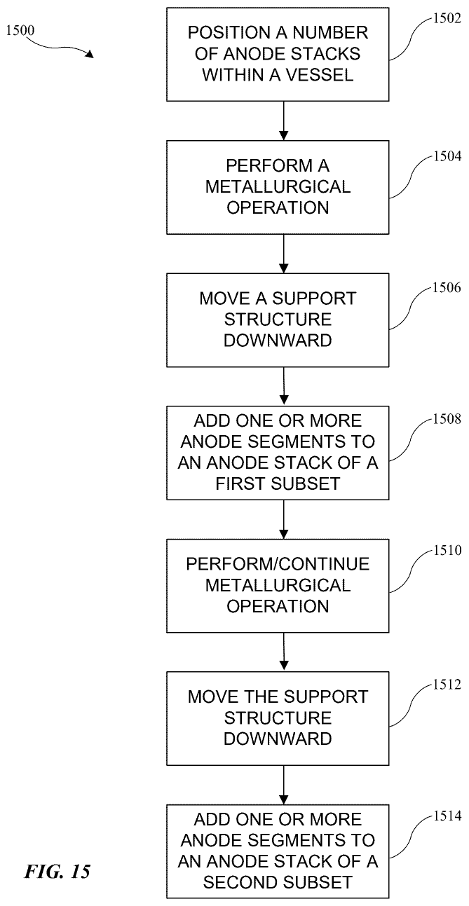

FIG. 15 is a flowchart of a process 1500 for continuously operating a metallurgical system that includes multiple electrode stacks. Process 1500 may be performed using any of the metallurgical systems described herein, including metallurgical systems 100, 200, 500, 700, 1100, 1300, and 1400. Process 1500 may begin at operation 1502 by positioning a number of electrode stacks within a refractory vessel of a metallurgical vessel, with at least one of the electrode stacks having a different length than at least one other electrode stack. Each electrode stack may be formed from one or more electrode segments. To provide the electrode stacks of different lengths, different numbers of electrode segments may be present in a given electrode stack and/or one or more of the electrode segments within the electrode stacks may have different lengths than a standard length of the electrode segments. A bottom end of each electrode stack may be disposed within an electrolyte within the refractory vessel, with the bottom ends of the electrode stacks being substantially aligned along a horizontal plane in some embodiments. The positioning of the electrodes stacks in such a manner may result in the top ends of at least the electrode stacks protruding from a top end of a lid of the refractory vessel at different distances, with longer electrode stacks protruding further from the refractory vessel than shorter electrode stacks.

At operation 1504, metallurgical operations, such as MOE, may be performed. For example, current may be passed through one or more current collectors, the electrolyte, and the number of electrodes, which may cause a reaction that generates heat within the refractory vessel. The reaction may gradually consume portions of the electrode stacks that are in contact with the electrolyte. As the electrodes stacks are consumed, a support structure from which the electrode stacks are suspended may be moved downward to lower the electrode stacks and maintain at least a portion of each electrode stack within the electrolyte at operation 1506. Once each electrode stack has reached a particular position within the refractory vessel and/or once the electrode stack has been consumed and shortened to a particular length, an additional electrode segment may be added to the electrode stack. Thus, in operation 1508, one or more new electrode segments may be added to a first subset of one or more electrode stacks. For example, additional electrode segments may be added to one or more of the electrode stacks (e.g., the shortest electrode stack(s)) using a process similar to process 1200 described herein. While the additional electrode segments are added to the first subset of electrode stacks, current may continue to be passed through the remaining electrode stacks, enabling the metallurgical system to remain in operation (e.g., metallurgical operations may be performed and/or continued) at operation 1510 during the electrode segment addition, which enables essentially continuous, indefinite operation of the metallurgical system, thereby reducing energy demands and reducing downtime of the metallurgical system.

As the electrode segments of the electrode stack are gradually consumed (which may occur during and/or after the additional electrode segments are added to the first subset of electrode stacks), the support structure may be lowered to lower each of the electrode stacks that are coupled to the support structure further into the refractory vessel to maintain a bottommost electrode segment of the electrode stack at a substantially constant vertical position within the refractory vessel at operation 1512. As a second subset of one or more of the electrode stacks is consumed and shortened to a particular length, one or more additional electrodes may be added the second subset of electrode stacks at operation 1514. Process 1500 may be continued for any number of subsets of electrode stacks and may be repeated for each of the subsets of electrodes stacks numerous times to keep the metallurgical system operating continuously for long periods of time.

The subsets of electrode stacks may each include any number of electrode stacks. For example, each subset may include at least one electrode stack, at least two electrode stacks, at least three electrode stacks, at least four electrode stacks, at least five electrode stacks, or more. In some embodiments, each subsets may include a same number of electrode stacks, while in other embodiments one or more of the subsets may have a different number of electrode stacks. Each electrode stack may include any number of electrode segments. For example, each electrode stack may include at least one electrode segment, at least two electrode segments, at least three electrode segments, at least four electrode segments, at least five electrode segments, or more depending on the size of each electrode segment and the size of refractory vessel. In some embodiments, each electrode stack may include a same number of electrode segments, while in other embodiments one or more of the subsets may have a different number of electrode segments.

In some embodiments, the length of length between electrode stacks within each subset may be selected such that only a single subset of electrode stacks needs to be added to at a given time. For example, the length of the electrodes stacks within each subset may be selected based on a total number of electrode stacks, a total number of subsets, a length of the electrode stacks, a duration of the electrode segment addition process, and/or other factors. In a particular embodiment, lengths of the subsets of electrode stacks may be incremented at set intervals. For example, an average length of the electrode stacks may be divided by a number of subsets to generate an interval for staggering the length of the subsets. Other staggers are possible, with the stagger being selected at a length that ensures that the time needed to perform the electrode segment addition procedure does not exceed the amount of time it takes the stagger to be consumed during operation (e.g., stagger distance multiplied by consumption rate). Such a stagger may ensure that only a single subset is being added to at a given time, although in some embodiments, multiple subsets may be added to simultaneously (but out of synch). In various embodiments, a length of the stagger may be at least 5% of an average length of the electrode stacks, at least 10% of an average length of the electrode stacks, at least 15% of an average length of the electrode stacks, at least 20% of an average length of the electrode stacks, at least 25% of an average length of the electrode stacks, at least 30% of an average length of the electrode stacks, at least 35% of an average length of the electrode stacks, at least 40% of an average length of the electrode stacks, at least 45% of an average length of the electrode stacks, at least 50% of an average length of the electrode stacks, or more.

It should be noted that the methods, systems, and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein. As used herein in the context of shapes, the terms “generally” and “substantially” are understood to mean that a large percentage of the shape of a component (e.g., greater than 70%, greater than 80%, greater than 90%, or more) has the described shape, however some smaller percentage of the component may stray from the shape described. For example, the component may include a number of protrusions, cutouts, and/or small components that prevent the component from perfectly matching the described shape.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A metallurgical assembly, comprising:
a metallurgical vessel;
an anode stack positioned partially within the metallurgical vessel;
a support structure positioned laterally outward from a peripheral surface of the anode stack; and
a clamp seated atop the support structure, the clamp being engageable with the anode stack, the clamp comprising:
a clamp body having an inner surface that defines an open interior, wherein the anode stack is received within the open interior;
a clamping surface coupled with the clamp body and that is laterally moveable relative to the inner surface to selectively engage the peripheral surface of the anode stack;
a tightening mechanism that is operably coupled to the clamping surface and that is configured to adjust a lateral position of the clamping surface; and
at least one electrically insulating member disposed between a bottom surface of the clamp body and an upward-facing surface of the support structure to electrically isolate the clamp from the support structure.

2. The metallurgical assembly of claim 1, wherein:
the support structure forms a top of the metallurgical vessel.

3. The metallurgical assembly of claim 1, wherein:
the clamping surface is arc-shaped.

4. The metallurgical assembly of claim 3, wherein:
a radius of the clamping surface is between 95% and 105% of a radius of the anode.

5. The metallurgical assembly of claim 1, wherein:
the clamping surface comprises a first clamping surface;
the tightening mechanism comprises a first mechanism; and
the clamp comprises:
a second clamping surface coupled to the clamp body at a different azimuthal position of the clamp body from the first clamping surface; and
a second tightening mechanism operably coupled to the second clamping surface configured to adjust a lateral position of the second clamping surface.

6. The metallurgical assembly of claim 5, wherein:
the first tightening mechanism and the second tightening mechanism are accessible from a single side of the anode.

7. The metallurgical assembly of claim 1, wherein:
the at least one electrically insulating member is coupled with the bottom surface of the clamp body.

8. A metallurgical electrode clamp, comprising:
a clamp body having an inner surface that defines an open interior;
a clamping surface coupled to the clamp body and that is laterally moveable relative to the inner surface;
a tightening mechanism that is operably coupled to the clamping surface and that is configured to adjust a lateral position of the clamping surface; and
at least one electrically insulating base member coupled to a bottom surface of the clamp body.

9. The metallurgical electrode clamp of claim 8, wherein:
the clamping surface comprises a first clamping surface;
the tightening mechanism comprises a first mechanism; and
the metallurgical electrode clamp comprises:
a second clamping surface coupled to the clamp body at a different azimuthal position of the clamp body from the first clamping surface; and
a second tightening mechanism operably coupled to the second clamping surface configured to adjust a lateral position of the second clamping surface.

10. The metallurgical electrode clamp of claim 9, wherein:
the first and second tightening mechanisms are oriented in a same direction relative to the clamp body.

11. The metallurgical electrode clamp of claim 9, wherein:
a tightening member of each of the first and second tightening mechanisms is positioned on a same half of the clamp body.

12. The metallurgical electrode clamp of claim 8, wherein:
the clamp body comprises a first semi-annular body and a second semi-annular body; and
first ends of the first semi-annular body and the second semi-annular body are removably joined together and second ends of the first semi-annular body and the second semi-annular body are removably joined together.

13. The metallurgical electrode clamp of claim 12, wherein:
the first ends of the first semi-annular body and the second semi-annular body are joined by a first removable pin and second ends of the first semi-annular body and the second semi-annular body are removably joined by a second removable pin.

14. The metallurgical electrode clamp of claim 8, wherein:
the clamping surface comprises at least one row of serrations.

15. The metallurgical electrode clamp of claim 8, wherein:
the clamping surface is disposed on an inward side of a cleat;
an outward side of the cleat comprises an angled surface;
the tightening mechanism comprises a wedge body that is movable within a channel; and
movement of the wedge body within the channel applies a lateral force to the angled surface of the cleat to adjust a lateral position of the clamping surface relative to the inner surface of the clamp body.

16. The metallurgical electrode clamp of claim 8, wherein:
the clamping surface is one of a plurality of clamping surfaces; and
the plurality of clamping surfaces are configured to collectively apply a force of between 8500 N and 270000 N.

17. The metallurgical electrode clamp of claim 8, wherein:
the clamping surface is one of a plurality of clamping surfaces; and
each of the plurality of clamping surfaces is configured to apply a pressure of no more than 50 MPa.

18. The metallurgical electrode clamp of claim 8, wherein:
the at least one electrically insulating base member comprises a plurality of electrically insulating feet.

19. The metallurgical electrode clamp of claim 8, wherein:
the clamping surface is arc-shaped.

20. A metallurgical electrode clamp, comprising:
a clamp body having an inner surface that defines an open interior;
a clamping surface coupled to the clamp body and that is laterally moveable relative to the inner surface;
a tightening mechanism that is operably coupled to the clamping surface and that is configured to adjust a lateral position of the clamping surface; and
at least one electrically insulating base member.
